(19) United States
(12) Patent Application Publication
(10) Pub. No.: US 2001/0030960 A1
(43) Pub. Date: Oct. 18, 2001

(54) Electronic mail system

(75) Inventors: Masahiro Nakada, Kawasaki (JP); Nobuyuki Sato, Kawasaki (JP); Yoshiaki Uchida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/741,492

(22) Filed: Dec. 19, 2000

(30) Foreign Application Priority Data
Apr. 18, 2000 (JP) 2000-116663

(51) Int. Cl. H04L 12/28

(52) U.S. Cl. 370/389; 370/401

(57) ABSTRACT

According to an electronic mail system of the present invention, if destination limiting information is included in a header of an electronic mail received from a mail client, a mail server identifies destinations designated in the header of the electronic mail into those within a transmission available area and those outside the transmission available area based on the destination limiting information, and transmits an electronic mail only to the destinations within the transmission available area. In this way, since the electronic mail is transmitted only to the destinations within the transmission available area, even if a destination is wrong, the electronic mail is prevented from reaching the wrong destination and secrecy of information in the electronic mail can be kept.

### BACKGROUND OF THE TNVENTTON

1. Field of the Invention

The present invention relates to an electronic mail system, more particularly to a technology for preventing an electronic mail from being transmitted to a wrong destination due to user's wrong designation of a destination of the electronic mail.

2. Description of the Related Art

There is an electronic mail as one method for communicating information. In recent years, users of electronic mails are increasing in number with the spread of the Internet. An electronic mail is communicated through a computer called a mail server between computers called mail clients in a computer network.

A mail client is a computer for executing software (called a “mailer”) for preparing, transmitting, receiving and referencing an electronic mail. A mail server is a computer for transmitting an electronic mail received from a mail client to another mail server corresponding to a destination, keeping an electronic mail received from another mail server for each destination, and giving a kept electronic mail to a mail client in response to a request form the mail client.

Data of an electronic mail (mail data) that can be handled by an electronic mail system are defined by the RFC822 (for example, ftp://ftp.iij.ad.jp/pub/RFC/rfc822.txt). An electronic mail consists of a “body” written by a user, and a “header” having information such as a destination of the mail, a title, and character codes.

If a mail client functions as a transmission terminal of an electronic mail, a mailer is started and transmission contents of an electronic mail are prepared by a user designating or inputting a body of the mail, a destination (an electronic mail address) and a title in the mail client. One of attributes of an electronic mail consisting of “TO”, “CC (carbon copy)” and “BCC (blind carbon copy)” is allocated to the designated destination, and is included in the header of the electronic mail. After the transmission contents of the electronic mail is decided, when the user instructs transmission of the electronic mail, the prepared electronic mail is transmitted to a mail server designated by the user in advance from the transmission terminal. Upon receiving the electronic mail, the mail server transmits the electronic mail to another mail server designated as a destination of the electronic mail in its header, or another mail server existing on a route to a mail server designated as a destination. In this way, the electronic mail is finally reaches the mail server designated as a destination and is kept there.

For example, if mail data have contents illustrated in FIG. 17, a mail server receiving the mail data transmitted from the transmission terminal is a computer specified by “server1.fujitsu.co.jp”, which transmits the mail data to a computer (another mail server) specified by “server2.fujitsu.co.jp”.

On the other hand, if the mail client functions as a receipt terminal and receives an electronic mail kept in a mail server, the receipt terminal checks whether or not an electronic mail having an electronic mail address of a user as a destination is kept in a mail server designated by the user in advance and, if the pertinent electronic mail is kept, issues a transfer request to the mail server. Upon receiving the transfer request from the receipt terminal, the mail server transmits mail data corresponding to the request to the receipt terminal. In this way, the receipt terminal obtains a desired mail data.

A user can select either a “new preparation” mode or a “reply” mode. “New preparation” is utilized when an electronic mail prepared anew is transmitted. “Reply” is utilized when a reply to the received electronic mail is sent to a sender of the electronic mail, a designated receiver of a reply, or a person to whom the electronic mail is multicasted (a participant in a multicast domain). In addition, the received electronic mail can be transferred to people other than the sender or the participant in the multicast domain. There also is a mailer that is provided with a “transfer” mode for this purpose.

When transmitting an electronic mail, a user must designate its destination. However, in the “reply” mode, an electronic mail address designated in a header of a received mail (an electronic mail address of a sender, a designation of a receiver of a reply, or a participant in a multicast domain) is automatically designated as an initial setting of a destination of a return mail (a reply destination).

Some electronic mails include, for example, information that is kept a secret within a predetermined area such as a company or an organization. If a user designates a wrong destination when transmitting such an electronic mail, there is a possibility that information that should be kept a secret is leaked out. Particularly, in the “reply” mode, since a reply destination is automatically set based on header information of a received mail, the possibility of wrong transmission of an electronic mail without a user noticing an error in the destination is higher than in the “new preparation” mode.

In addition, in the conventional art, after a user instructs transmission of an electronic mail, there is no means prepared for canceling the transmission of the electronic mail even if the user notices an error of a destination. Thus, the user has to contact the destination of the wrong transmission to ask deletion without reading the electronic mail transmitted erroneously when the user notices the error after instructing the transmission.

Here, as a method for relieving a user of an error in designating a destination, there is an electronic mail transmission control method disclosed in the Japanese Patent Application Laid-open No. Sho 63-146538 (hereinafter referred to as “first related technology”). The first related technology has a host computer for controlling transmission of an electronic mail between terminals and, if a receiver of an electronic mail is not registered in a destination management list, arranges not to transmit the electronic mail to the receiver. However, with the first related technology, a sender of an electronic mail cannot communicate an electronic mail to a receiver who is not registered in the destination management list. Thus, registration of receivers in the destination management list and maintenance of the list are inconvenient. In addition, the more the number of receivers increases, the more a storage area of a storage medium storing the destination management list is suppressed.

In addition, as a related technology of the present invention, there is communication equipment with a replay function disclosed in the Japanese Patent Application Laid-open No. Hei 10-341252 (hereinafter referred to as “second related technology”). However, since the second related technology has to use two kinds of mail addresses, and uses a domain name of a sender in order to determine if relay is allowed, even if there is an error in a destination, the second related technology cannot relieve a user of the error.

### SUMMARY OF THE INVENTTON

The present invention has been devised in view of the above drawbacks and it is an object of the present invention to provide an electronic mail system that, when an electronic mail with a wrong destination designated by a user is transmitted, can prevent the mail from reaching the destination.

The present invention adopts the following configuration in order to attain the above-mentioned object. That is, the present invention is an electronic mail system that is provided with (1) a determination portion for determining whether or not destination limiting information is included in an electronic mail that is planned to be transmitted; (2) an identification portion for identifying whether or not the electronic mail should be transmitted to destinations included in a header of the electronic mail based on destination limiting information if it is determined by the determination portion that the destination limiting information is included; and (3) a transmission portion for transmitting the electronic mail only to a destination that is identified by the identification portion as a destination to which the electronic mail should be transmitted.

In accordance with the present invention, it is identified (determined) whether or not an electronic mail should be transmitted to a single or a plurality of destinations included in a header based on destination limiting information, and the electronic mail is transmitted only to destinations that are identified as those to which the electronic mail should be transmitted.

Therefore, for example, when an electronic mail including information that should be kept a secret is transmitted, if destination-limiting information is included in the electronic mail, the electronic mail is not transmitted to a wrong destination even if a destination other than a desired destination is erroneously included. In this way, leakage of information can be prevented.

Destination limiting information is made to include, for example, specific information in a transmission available area of an electronic mail. For example, it is preferable to adopt a domain name included in a desired destination as destination limiting information. Specific information (a domain name) of an area included as destination limiting information may be signal or plural. In addition, a combination of a domain name and a host name in an electronic mail address may be used as specific information of an area.

An electronic mail system in accordance with the present invention can be configured as an electronic mail apparatus that realizes all elements of the present invention in one apparatus. Alternatively, the electronic mail system may be configured such that all the elements of the present invention are realized by connecting a plurality of apparatuses realizing at least one of the elements of the present invention via a network (for example, an IP network such as the Internet, an Intranet and an Extranet). For example, the electronic mail system of the present invention may be configured such that the system is realized in a mail server receiving an electronic mail from a mail client, or may be realized in a mail client. Alternatively, the electronic mail system of the present invention may be configured such that the system is realized in a mail client and a mail server.

### BRIEF DESCRTPTION OF THE DRAWINGS

Other objects and advantages of the present invention will become apparent during the following discussion in conjunction with the accompanying drawings, in which:

FIG. 1 is a schematic illustration of an example of a configuration of an electronic mail system in accordance with an embodiment of the present invention;

FIG. 2 is a schematic illustration of hardware configuration of a terminal apparatus (a mail client) shown in FIG. 1;

FIG. 3 is a schematic illustration of hardware configuration of a mail server shown in FIG. 1;

FIG. 4 is a view illustrating an example of a display of a main window;

FIG. 5 is a view illustrating an example of a display of a destination limiting list registration window;

FIG. 6 is a view illustrating an example of a display of a mail edit window;

FIG. 7 is a flowchart describing operations of an electronic mail system in a first embodiment;

FIG. 8 is a view illustrating an example of mail data in the first embodiment;

FIG. 9 is a flowchart describing operations of an electronic mail system in a second embodiment;

FIG. 10 is a view illustrating an example of mail data in the second embodiment;

FIG. 11 is a view illustrating an example of an electronic mail to be transmitted to inside of an area to which transmission is possible;

FIG. 12 is a view illustrating an example of another electronic mail (a limited mail) to be transmitted to outside of the area to which transmission is possible;

FIG. 13 is a flow chart describing operations of an electronic mail system in a third embodiment;

FIG. 14 is a view illustrating an example of a mail edit window in the third embodiment;

FIG. 15 is a flow chart describing mail keeping processing shown in FIG. 13;

FIG. 16 is a flow chart describing kept mail transmission/cancellation processing shown in FIG. 13; and

FIG. 17 is a view illustrating an example of mail data.

### DESCRIPTION OF THE PREFERRED EMBODTMENT

Embodiments of the present invention will now be described with reference to the drawings.

[First Embodiment]

<Network Configuration>

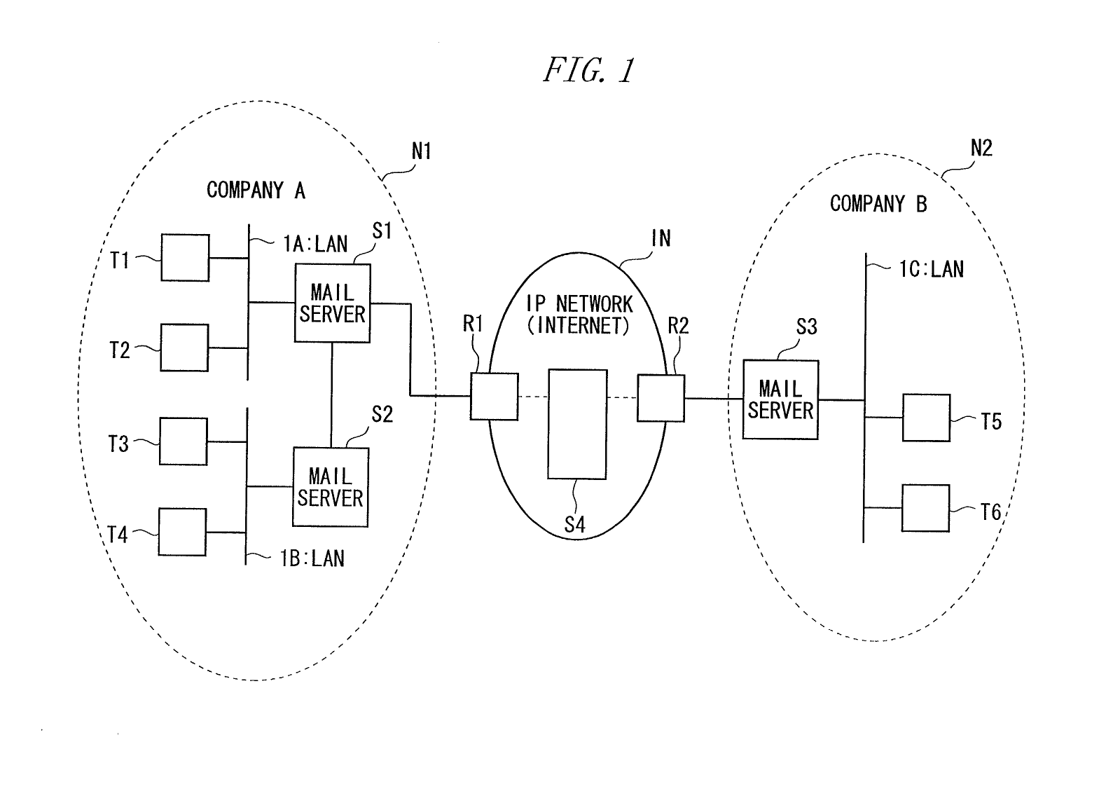

FIG. 1 is a schematic illustration of an example of a configuration of an electronic mail system in accordance with an embodiment. In FIG. 1, an electronic mail system is illustrated that is formed by connecting a network N1 and a network N2 to an Internet IN.

The network N1 is managed by a company A. The network N1 consists of terminal apparatuses T1 and T2 and a mail server S1 connected to each other via an intra-office LAN 1A, as well as terminal apparatuses T3 and T4 and a mail server S2 connected to each other via an intra-office LAN 1B. The mail server S1 is connected to the mail server S2, and is connected to a router R1 that is connected to the Internet IN.

The network N2 is managed by a company B. The network N2 consists of terminal apparatuses T5 and T6 and a mail server S3 connected to each other via an intra-office LAN IC. The mail server S3 is connected to a router R2 that is connected to the Internet IN.

The network N1 and the network N2 can transmit and receive an electronic mail via the Internet IN. The Internet IN includes a mail server S4. The mail server S4 is positioned on a route of an electronic mail transmitted and received between the networks N1 and N2, and relays the electronic mail.

<Hardware Configuration of a Terminal Apparatus (a Mail Client)>

Each of the terminal apparatuses T1 through T6 is a computer such as a personal computer installed with a mailer, a workstation, a computer superior to them, and a mobile computer, and functions as a mail client (an electronic mail apparatus).

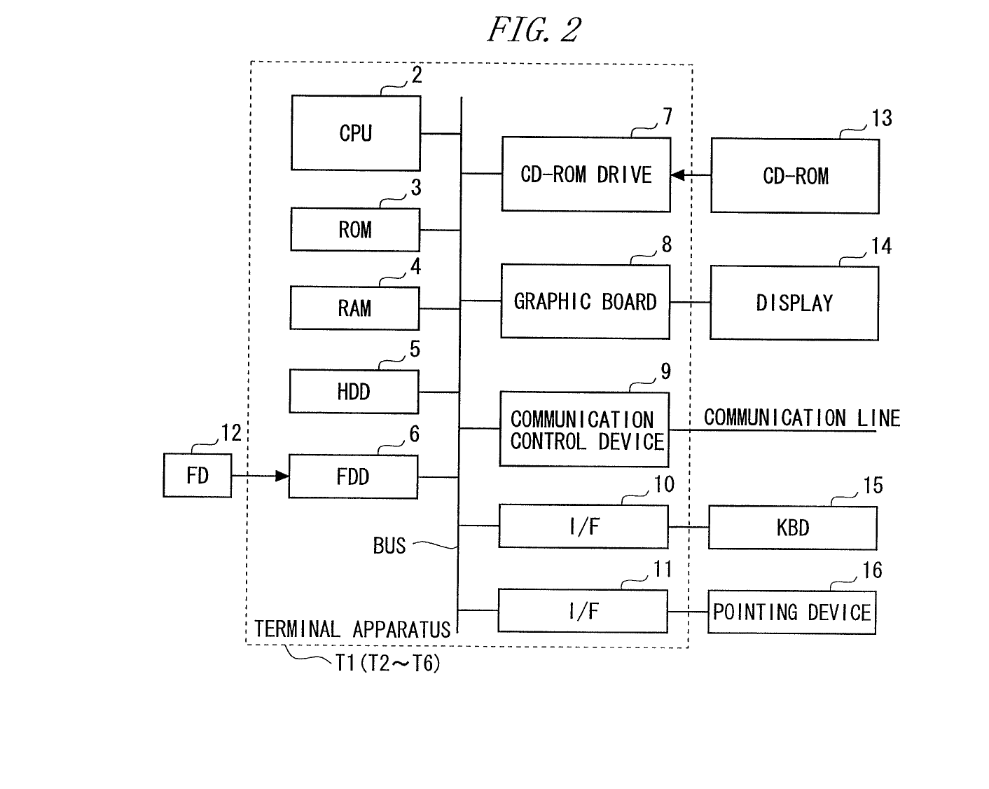

FIG. 2 is a schematic illustration of an example of configuration of each of the terminal apparatuses T1 through TG shown in FIG. 1. Since each of the terminal apparatuses T1 through T6 has the same configuration, the terminal apparatus T1 will be described as an example. In FIG. 2, the terminal apparatus T1 is provided with a Central Processing Unit (CPU) 2, a Read Only Memory (ROM) 3, a Random Access Memory (RAM) 4, a Hard Disk Drive (HDD: including a hard disk) 5, a Floppy Disk Drive (FDD) 6, a CD-ROM Drive 7, a graphic board 8, a communication control device 9, and interface portions (I/F) 10 and 11 that are mutually connected by a bus.

A display 14 is connected to the graphic board 8. The display 14 is, for example, a Cathode-Ray Tube (CRT), a Liquid Crystal Display (LCD), or a plasma display. A keyboard (KBD) 15 is connected to the I/F 10. A pointing device (PD) 16 is connected to the I/F 11. The PD 16 is, for example, a mouse, a trackball, a flat space, or a joystick.

The ROM 3 stores a start-up program. The start-up program is executed by the CPU 2 when a power source of the terminal apparatus T1 is inputted. In this way, an Operating System (OS) stored in the HDD 5 and a single or a plurality of drivers for display processing or communication processing are loaded in the RAM 4, and various kinds of processing and control are made executable.

A program for controlling the terminal apparatus T1 is developed on the RAM 4. The RAM 4 is utilized as a work area of the CPU 2, and holds display data and the like for displaying results of processing by the program and temporary data for processing on the screen of the display 14. The display data developed on the RAM 4 is communicated to the display 14 via the graphic board 8, and the display 14 displays display contents (text, image, etc.) corresponding to the display data on the screen.

The HDD 5 is a device for recording or reading a program, control data, text data, image data and the like in or from the hard disk in accordance with an instruction of the CPU 2.

The FDD 6 executes reading or writing of a program, control data, text data, image data and the like from or in a floppy disk (FD) 12 in accordance with an instruction of the CPU 2.

The CD-ROM drive 7 reads a program or data recorded in a CD-ROM (read only memory using a compact disk) 13 in accordance with an instruction of the CPU 2.

The communication control device 9 executes transmission and reception of data, or upload or download of a program and data to and from other apparatuses using communication lines connected to the terminal apparatus T1.

The KBD 15 is provided with a plurality of keys (a character input key, a cursor key, etc.), and is used by an operator to input an instruction or data in the terminal apparatus T1. The PD 16 is used for inputting an instruction using a cursor displayed on the display 14.

The CPU 2 executes various kinds of programs stored in the ROM 3, the RAM 4, the HDD 5,the FD 12 and the CD-ROM 13 that are equivalent to a recording medium of the present invention, gives an instruction to each element in the terminal apparatus T1, and controls operations of the terminal apparatus 1 and its peripheral apparatuses 13 through 16.

In this embodiment, a mailer held by the CD-ROM 13 is installed in the HDD5, and the CPU 2 causes the terminal apparatus T1 to function as a mail client and realizes a preparation portion and an information adding portion of the present invention by loading the program of the mailer in the RAM 4 from the HDD 5 to execute it.

Further, a program and data held in a recording medium such as the HDD 5 may be arranged to be held in advance, or may be arranged such that a program and data downloaded from other apparatuses are held in the recording medium.

<Hardware Configuration of a Mail Server>

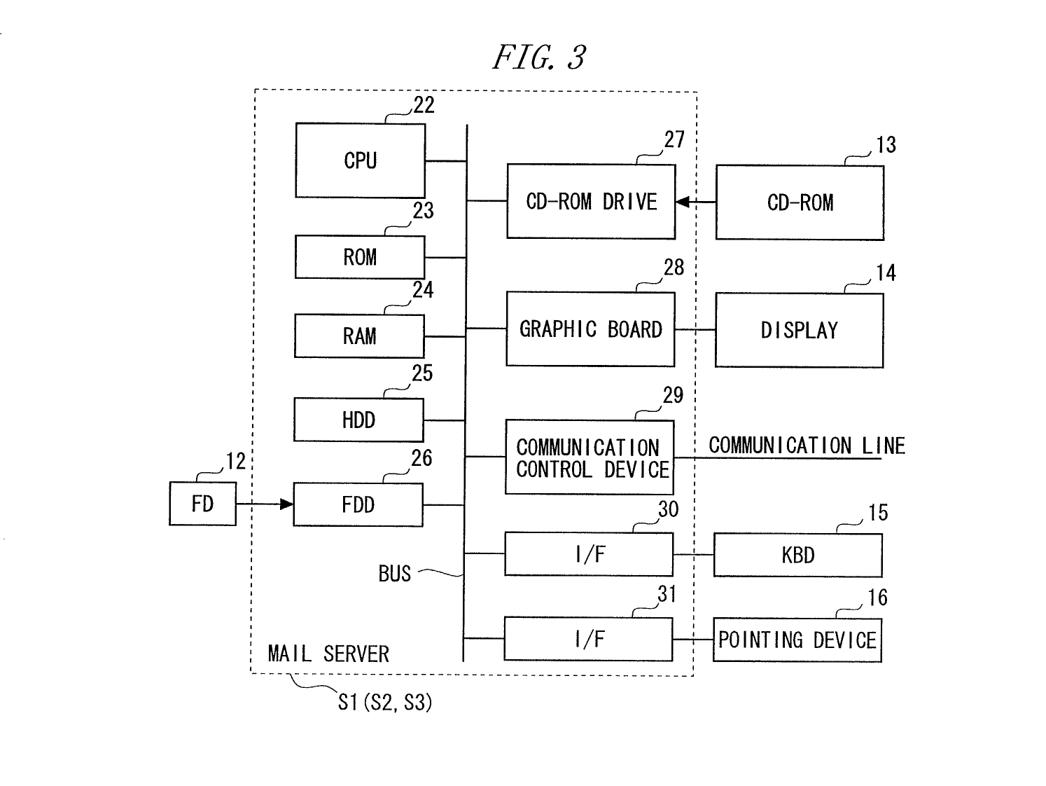

Each of the mail servers (electronic mail apparatuses) S1 through S4 is composed using a computer such as a personal computer, a workstation, or a dedicated server machine. FIG. 3 is a schematic illustration of hardware configuration of each of the mail servers S1 through S4 shown in FIG. 1. Since each of the mail servers S1 through S4 has substantially the same configuration, the mail server S1 will be described here.

In FIG. 3, the mail server S1 is provided with a CPU 22, an ROM 23, an RAM 24, an HDD (including a hard disk) 25, an FDD 26, a CD-ROM drive 27, a graphic board 28, a communication control device 29, and I/Fs 30 and 31 that are mutually connected by a bus. Since each element in the mail server S1 has substantially the same function as each element of the above-mentioned terminal apparatus T1, explanation on the element is omitted. A program for a mail server is installed in the HDD 25, and the function as the mail server SI is shown, and a determination portion, an identification portion and a transmission portion of the present invention are realized by the CPU 22 loading the program from the HDD 25 to the RAM 24 to execute it.

Further, the hardware configuration shown in FIG. 3 is the one in which a personal computer or a workstation is used as the mail server S1, a graphic board 28 and each of the I/Fs 30 and 31 are not essential elements of a computer for functioning as the mail server S1.

<GUI of a Mail Client>

A Graphical User Interface (GUI) to be displayed on the display 14 by the CPU 2 of the terminal apparatus T1 executing the mailer will now be described.

(Main Window)

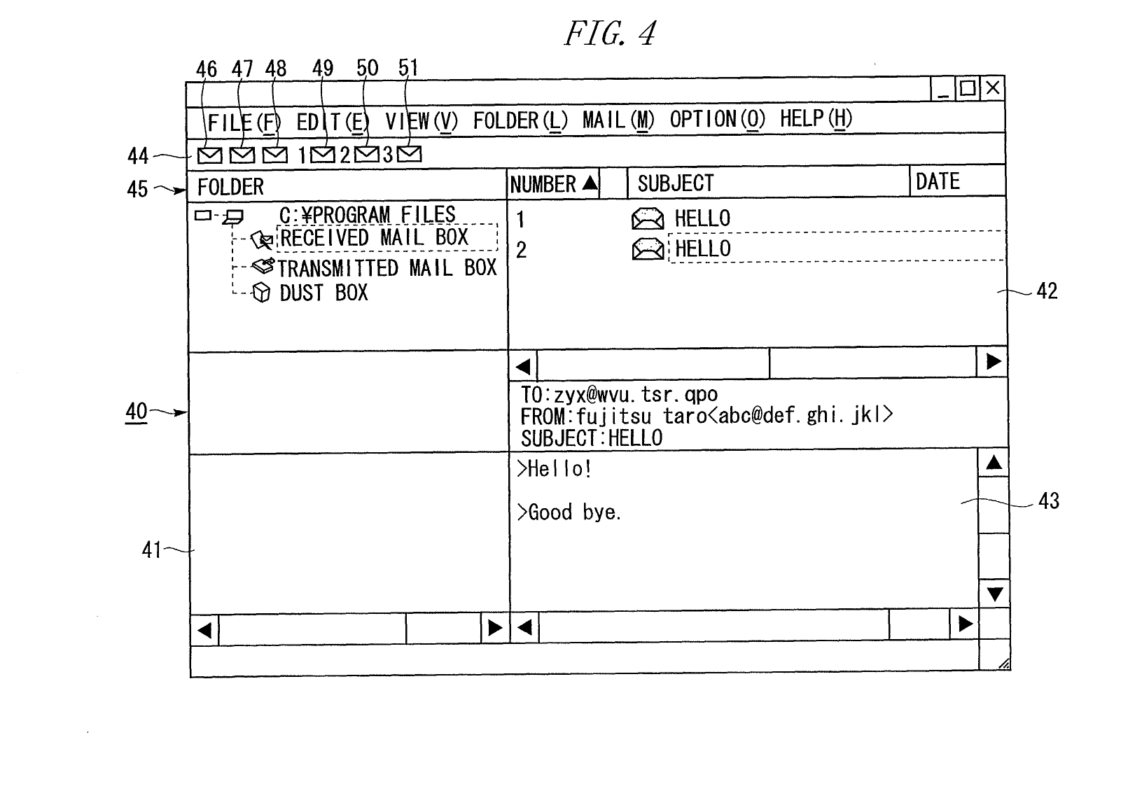

FIG. 4 is a view illustrating an example of a display of a main window 40 of a mailer. As shown in FIG. 4, the mail window 40 has a folder display area 41, a mail list display area 42, a mail display area 43, a menu bar 44, and a group of command buttons 45.

A plurality of folders (directories) storing electronic mails are displayed together with its hierarchical structure in the folder display area 41. In FIG. 4, a “receipt box” storing electronic mails received by the terminal apparatus T1 (received mails) and a “transmission box” storing electronic mails transmitted or to be transmitted from the terminal apparatus T1 (transmitted mails) are illustrated as folders.

A list of titles of the electronic mails stored in the folders designated in the folder display area 41 is displayed in the mail list display area 42. Specifically, if the folder “receipt box” is designated, a list of titles of the received mails stored in the “receipt box” is displayed in the mail list display area 42.

On the other hand, if the folder “transmission box” is designated, a list of titles of the transmitted mails stored in the “transmission box” is displayed in the mail list display area 42. In FIG. 4, the situation in which the list of titles of the received mails stored in the “receipt box” is displayed is illustrated.

In the mail display area 43, header information (a destination, a sender and a title) and a body of an electronic mail corresponding to the title designated in the mail list display area 42 are displayed.

The menu bar 44 is a column in which a plurality of command menus names of the mailer are displayed, and, when any of the menu names is designated, a plurality of command names belonging to the menu name are displayed as a pull-down menu.

The group of command buttons 45 is a plurality of buttons indicated by icons for a user to designate a command, and a new preparation button 46, a transmission box store button 47, a reply button 48, a first limited reply button 49, a second limited reply button 50 and a third limited reply button 51 are provided from the left to the right in order in FIG. 4.

The new preparation button 46 is the one that is pressed when a user prepares an electronic mail anew. The transmission box store button 47 is the one that is pressed for the user to store the prepared electronic mail in the “transmission box”.

The reply button 48 and each of the first to the third limited reply buttons 49 through 51 are the ones that are pressed when the user prepares a reply mail to a received mail. It should be noted that the reply button 48 is utilized when a reply mail is transmitted only to a sender of the received mail or a designated destination, and each of the first to the third limited reply button 49 through 51 is utilized when a reply mail is also transmitted to an electronic mail address of “CC” indicated in the header of the received mail. Further, although the “transfer” button is not provided in this embodiment, the received mail can be transferred to others by changing a destination address after pressing the reply button 48.

(Destination Limiting List Registration Window)

In a case the main window 40 is displayed, if a user clicks an “option” in the menu bar 44 using, for example, the PD 16, a destination limiting list registration window 52 (hereinafter shown as the “registration window 52”) is displayed on the main window 40 or in place of the main window 40.

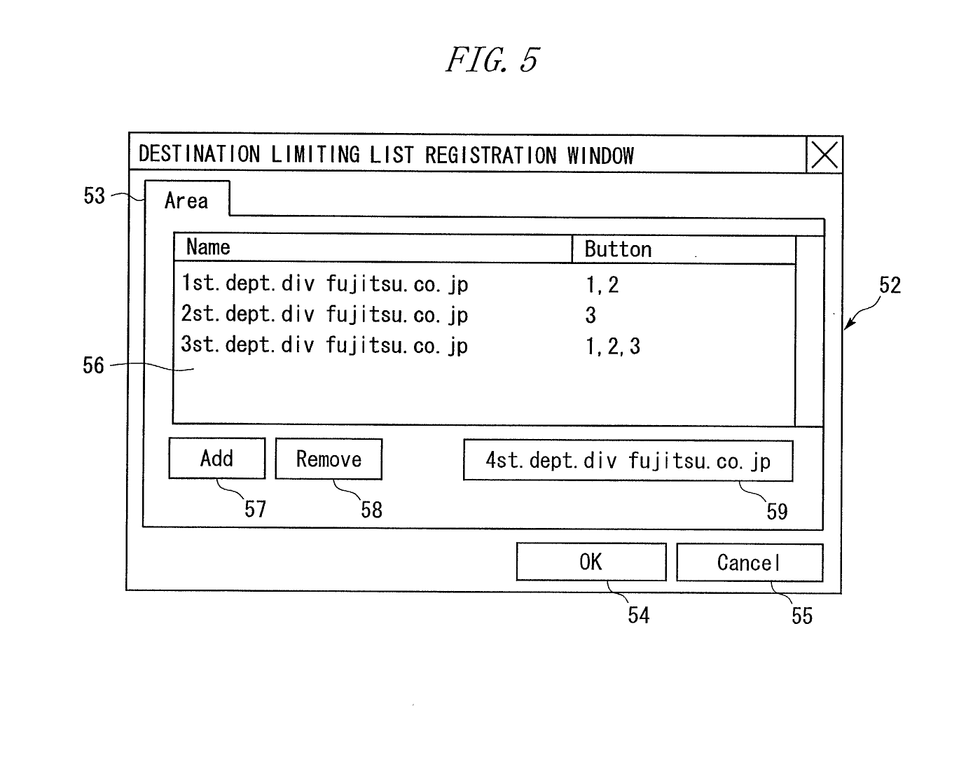

FIG. 5 is a view illustrating an example of a display of the registration window 52. The registration window 52 has a tub 53, an OK button 54 and a cancel button 55. The tub 53 has a transmission available area list 56 (hereinafter referred to as the “list 56”), an add button 57, a delete button 58 and a new transmission available area input column 59.

The OK button 54 is the one for deciding contents of the list of the tub 53. On the other hand, the cancel button 55 is utilized if the decided contents of the list 56 at the time when the OK button 54 is pressed last are to be maintained.

A list of domain names to be set as a transmission available area of an electronic mail (X-Arealimitation) is displayed in the list 56. In an example shown in FIG. 5, domain names “1st.dept.div.fujitsu.co.jp”, “2nd.dept.div.fujitsu.co.jp” and “3rd.dept.div.fujitsu.co.jp” are displayed.

A new domain name can be added in the list 56 by a user inputting a desired domain name in the new transmission available area input column 59 and pressing the add button 57. On the other hand, when a user presses the delete button 58 after designating a domain name displayed on the list 56, the designated domain name is deleted from the list 56.

In addition, a user can allocate at least one of the first to the third limited reply button 49 through 51 shown in FIG. 4 to each domain name displayed in the list 56. When the button is allocated by the user, a number indicating the allocated button is displayed in the right side of the domain name in the list 56.

FIG. 5 shows the situation in which the first limited reply button 49 (a button number 1) and the second limited reply button 50 (a button number 2) are allocated to the domain name “1st.dept.div.fujitsu.co.jp”, the third limited reply button 51 (a button number 3) is allocated to the domain name “2nd.dept.div.fujitsu.co.jp”, and the first to the third reply buttons 49 through 51 are allocated to the domain name “3rd.dept.div.fujitsu.co.jp”.

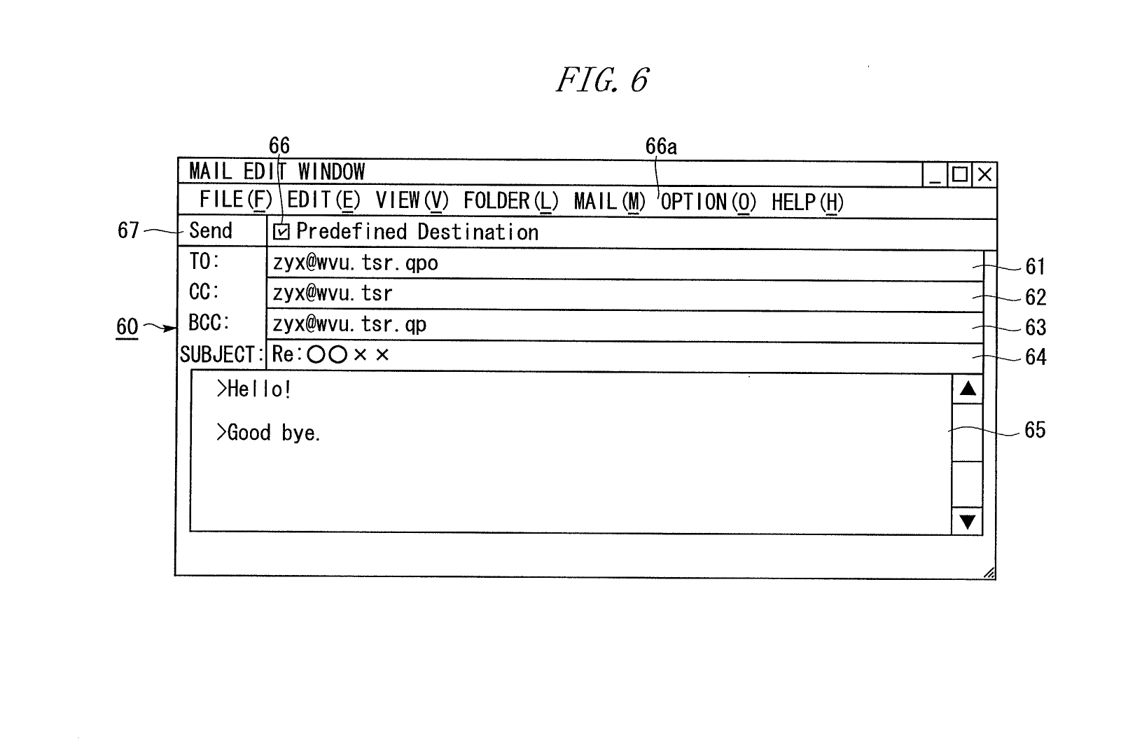

The registration window 52 is deleted from the display 14 by pressing the OK button 54 or the cancel button 55. At this point, if the registration window 52 is displayed in place of the main window 40, the main window 40 is displayed on the display 14 again. Then, contents of the list 56 at the time when the OK button 54 is pressed last are reflected in contents of the mail edit window 60 (see FIG. 6) displayed by pressing each of the first to the third limited reply buttons 49 through 51.

(Mail Edit Window)

FIG. 6 is a view illustrating an example of a display of a mail edit window 60. The mail edit window 60 has address input columns 61 through 63, a title input column 64, a body input column 65, a check column 66, and a transmission button 67.

The address input column 61 is the column for inputting an electronic mail address to which the mail attribute of “TO” is allocated as an electronic mail address of a reply mail to the received mail designated in the main window 40. In the address input column 61, the electronic mail address (the address of the sender) indicated in the “TO” row of the header of the received mail designated in the main window 40, or the electronic mail address designated as the destination of the reply mail is automatically designated (displayed) as an initial setting.

The address input column 62 is the column for inputting an electronic mail address to which the mail attribute “CC” is allocated as an electronic mail address of a reply mail to the received mail designated in the main window 40. In the address input column 62, the electronic mail address indicated in the “CC” row of the header of the received mail designated in the main window 40 is automatically designated (displayed) as an initial setting.

The address input column 63 is the column for inputting an electronic mail address to which the mail attribute of “BCC” is allocated as an electronic mail address of a reply mail to the received mail designated in the main window 40.

The title input column 64 is the column for a user to input a title (or an object) of a reply mail. In the title input column 64, a title name with “Re:” indicating a reply added at the top of the title of the received mail designated in the main window 40 is automatically designated (displayed) as an initial setting.

The body input column 65 is the column for a user to input a body of an electronic mail. In the body input column, the body of the received mail designated in the main window 40 is displayed as an initial setting. In this way, a user can prepare a reply mail by editing and citing the received mail.

The check column 66 is the column for setting whether or not the setting of the transmission available area that is set using the registration window 52 is made valid or invalid. Characters “Predefined Destination” instructing a user to designate valid/invalid of the setting is displayed in the right side of the check column 66.

If no check mark is entered in the check column 66, data (mail data) of an electronic mail prepared in the mail edit window 60 is transmitted to all the electronic mail addresses designated in each of the address input columns 61 through 63. On the other hand, if a user enters a check mark in the check column 66 by the operation of the KBD 15 or the PD 16, the prepared mail data is transmitted to an electronic mail address including the domain name set in the registration window 52 among the designated electronic mail addresses.

Further, if the mail edit window 60 is displayed by pressing the limited reply button allocated to the domain name registered in the list 56, the mail edit window 60 is displayed with the check mark entered in the check column 66. A user can remove the displayed check mark if necessary by the operation of the KBD 15 or the PD 16.

The transmission button 67 is an input button for instructing transmission that is pressed after a user finishes inputting all the mail data in the mail edit window 60. When the transmission button 67 is pressed, contents of a mail data displayed in the mail edit window 60 at that point is decided as contents of transmission, and transmission processing for transmitting the mail data to an electronic mail address designated as a destination is started.

In addition, a menu 66a is provided in the mail edit window 60, and when a user clicks the menu 66a using the PD 16, the registration window 52 is displayed simultaneously with the mail edit window 60. Therefore, the user can call and set the registration window 52 while using the mail edit window 60.

Further, the mail edit window 60 shown in FIG. 6 is also displayed when the new preparation button 46 and the reply button 48 are pressed. However, the mail edit window 60 to be displayed by pressing the new preparation button 46 is in the state in which no electronic mail address (destination) is designated in each of the address input columns 61 through 63 as an initial setting.

On the other hand, the mail edit window 60 to be displayed by pressing the reply button 48 has, as an initial setting, the electronic mail address indicated in the “TO” row of the header of the received mail designated in the main window 40 (address of sender) or the electronic mail address designated as a destination of a reply mail to be displayed in the address input column 61.

In addition, in the registration window 52, the new preparation button 46 and the reply button 48 can be allocated to the domain name registered in the list 56. Then, the registration contents of the registration window 52 are reflected in the check column 66 of the mail edit window 60 to be displayed by pressing the new preparation button 46 or the reply button 48. Thus, limitation of a transmission area of an electronic mail can also be set when the electronic mail is transmitted utilizing the new preparation button 46 and the reply button 48.

<Operational Examples of the First Embodiment>

Operational examples of the electronic mail system according to the first embodiment will now be described. Operations when a reply mail is transmitted to a received mail from the terminal apparatus T1 (the electronic mail address: taro@server1.fujitsu.co.jp) will be described as an example. A received mail to be described in this example is an electronic mail from the terminal apparatus T3 (the electronic mail address: hanako@server2.fujitsu.co.jp) in which the terminal apparatus T1 (the electronic mail address: taro@server1.fujitsu.co.jp) is designated in the “TO” and the terminal apparatus T5 (the electronic mail address: saburou@mail.hokano.co.jp) is designated in the “CC”. In addition, each of the terminal apparatuses T1 through T4, as intra-office computers in company A, is considered to have an electronic mail address including the common domain name “fujitsu.co.jp” registered as an account.

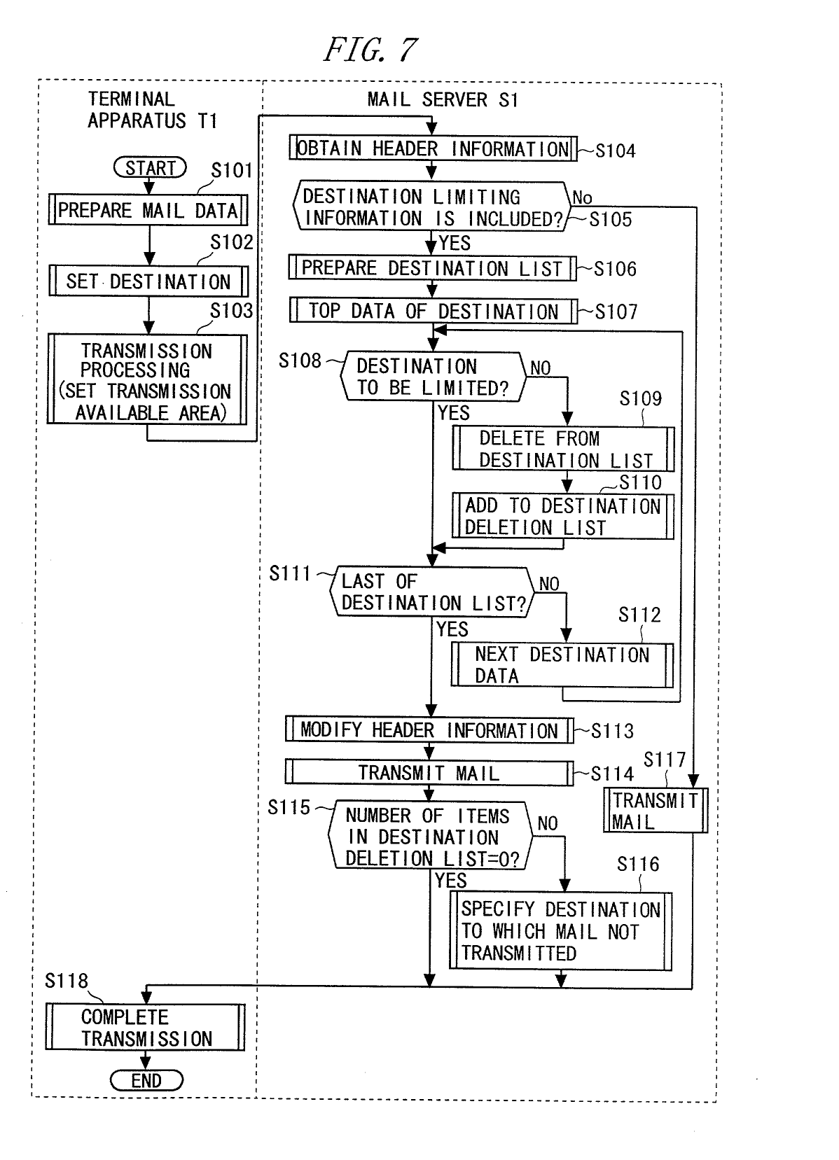

FIG. 7 is a flow chart describing processing of each of the terminal apparatuses T1 through T4 shown in FIG. 2 by the CPU 2, and processing of the mail server S1 shown in FIG. 3 by the CPU 22. However, the processing is described here as operations of the terminal apparatus T1 and the mail server S1 based on the above-mentioned premises.

When a user inputs an instruction to start up the mailer in the terminal apparatus 2 using the KBD 15 or the PD16, the CPU 2 of the terminal apparatus T1 starts the processing shown in FIG. 7. In step S101, the CPU 2 executes processing for preparing mail data. That is, when the instruction to start up the mailer is inputted, the CPU 2 displays the main window 40 (FIG. 4) on the display 14 by executing the program of the mailer.

When transmitting a reply mail to the above-mentioned received mail to all the destinations (“TO” and “CC”) of the received mail, the user designates the above-mentioned received mail using the displayed main window 40. The user subsequently presses any of the first to the third transmission limited buttons 49 through 51. However, if the user wishes to limit a transmission area, the user presses the limited reply button to which a desired transmission available area is allocated. In this example, it is assumed that the user has already set the following transmission limited area using the registration window 52 irrespective of the contents shown in FIG. 5.

Operations of an electronic mail system in a first embodiment Transmission limited area: Domain name “fujitsu.co.jp” Button allocated to the domain name: First limited reply button

When the user presses the first limited reply button 49 in accordance with the above-mentioned assumption, the CPU 2 displays the mail edit window 60 on the display 14. At this point, the CPU 2 displays the mail edit window 60 in the following states as an initial setting.

(1) The electronic mail address “hanako@server2.fujitsu.co.jp” of the terminal apparatus T3 (the sender) is displayed in the address input column 61.

(2) The electronic mail address “saburou@mail.hokano.co.jp” of the terminal apparatus T5 is displayed in the address input column 62.

(3) The title with “Re:” attached to the top of the title of the received mail is displayed in the title input column 64.

(4) The check mark indicating the limitation of the transmission available area “fujitsu.co.jp” is valid is entered in the check column 66.

(5) The body of the received mail is displayed in the body input column 65.

When the mail edit window 60 is displayed, the user designates destinations (“TO”, “CC” and “BCC”)using the displayed window 60 and edits the body. When the designation of the destinations and the editing of the body are completed, the user designates whether or not the reply mail is transmitted to the transmission limited area only using the check input column 66 (step S102).

The user presses the transmission button 67 when the input and the designation of the mail data using the mail edit window 60 are completed. Then, the CPU 2 determines that an instruction to transmit the mail data is inputted by the user, decides contents of the mail data, and starts transmission processing based on the contents (step S103). In this example, it is assumed that the user does not change the initial setting of the destinations, and the transmission button 67 is pressed in the state in which the check mark is entered in the check column 66.

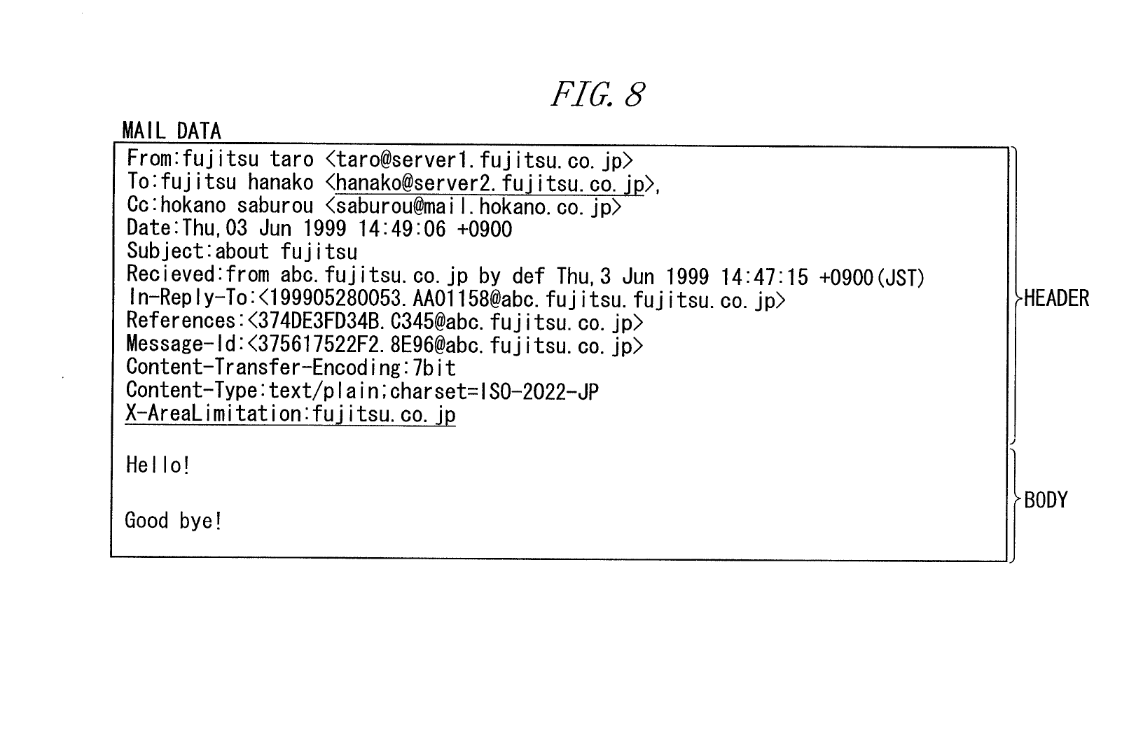

In the transmission processing, the CPU 2 prepares mail data consisting of a header and a body shown in FIG. 8 ((corresponding to the preparation portion)). That is, as shown in FIG. 8, the CUP 2 adds a predetermined header information (the electronic mail address of the sender, the electronic mail address of the destination, etc.) as a header before the body of the electronic mail ((corresponding to the information adding portion)). At this point, the CPU2 reflects the check mark entered in the check column 66 and inserts, as destination limiting information of the electronic mail, the character string of “X-AreaLimitation:fujitsu.co.jp” consisting of its identifier “X-AreaLimitation” and a transmission available area “fujitsu.co.jp”. Further, although the name of the identifier is assumed to be “X-AreaLimitation” in this example, it can be freely selected. Thereafter, the mail data is transmitted to the mail server S1 from the terminal apparatus T1 through the LAN 1A in accordance with the SMTP (Simple Mail Transfer Protocol).

When the mail data is received from the terminal apparatus T1, the CPU 22 of the mail server S1 obtains header information from the received mail data (step S104), and advances the processing to step S105.

In S105, the CPU 22 determines whether or not the destination limiting information is included in the header information ((corresponding to the determination portion)). That is, the CPU 22 determines whether or not “X-AreaLimitation” as the identifier of the destination limiting information is included in the header information. At this point, if the destination limiting information is not included, the CPU 22 advances the processing to step S117 assuming that the transmission available area is not limited. On the other hand, if the destination limiting information is included, the CPU 22 advances the processing to step S106. In this example, “X-AreaLimitation:fujitsu.co.jp” is included in the header information as the destination limiting information. Thus, the CPU 22 specifies “fujitsu.co.jp” corresponding to the identifier as the transmission available area, and advances the processing to step S105.

In S106, the CPU 22 prepares a list of destinations to which the reply mail should be transmitted ((corresponding to the first list)) on the RAM 24. That is, the CPU 22 prepares a list in which copies of the destinations included in the header information are registered on the RAM 24. In this example, the electronic mail address “hanako@server2.fujitsu.co. jp” of the terminal apparatus T3 and the electronic mail address “saburou@mail.hokano.co.jp” of the terminal apparatus T5 are extracted from the header information and registered in the destination list. Thereafter, the processing moves to step S107.

In step S107, the CPU 22 takes out an electronic mail address registered at the top of the destination list. Thereafter, the processing moves to step S108.

In step S108, the CPU 22 determines whether or not the electronic mail address taken out in step S107 corresponds to the destination that should be limited. That is, the CPU 22 determines whether or not the taken out electronic mail address is an electronic mail address in the transmission available area by determining whether or not the electronic mail address includes the domain name indicating the transmission available area. At this point, if it is determined that the electronic mail address does not include the domain name (step S108; N), the CPU 22 advances the processing to step S109 assuming that the electronic mail address is not included in the transmission available area. On the other hand, if it is determined that the electronic mail includes the domain name (step S108; Y), the CPU 22 advances the processing to step S111.

In step S109, the CPU 22 deletes the electronic mail address taken out in step S107 from the destination list, and advances the processing to step S110.

In step S110, the CPU 22 prepares a destination deletion list ((corresponding to the second list)) on the RAM 24, and adds the electronic mail address deleted from the destination list to this destination deletion list. Further, the destination deletion list is prepared only in the first step S110 when the processing shown in FIG. 7 starts, and the destination deletion list prepared in the preceding step S110 is used in step S110 of two or more rounds.

In step S111, the CPU 22 determines whether or not the electronic mail address taken out in step S107 is the electronic mail address registered at the end of the destination list and, if it is not (step S111; N), advances the processing to step S112. On the other hand, if the taken out electronic mail address is determined to be the electronic mail registered at the end (step Sill; Y), the CPU 22 advances the processing to step S113 assuming that the determination of step S108 has been made for all the electronic mail address registered in the destination list.

In step S112, the CPU 22 takes out an electronic mail address that is registered next to the electronic mail address taken out the last time from the destination list, and returns the processing to step S108.

In this way, the CPU 22 identifies whether or not the destination in the header is the destination to which the electronic mail should be transmitted by the loop processing of step S108 through S112. That is, the CPU 22 determines whether or not each electronic mail address registered in the destination list is within the transmission available area (the first area), deletes electronic mail addresses outside the transmission available area (corresponding to the second area) from the destination list, and registers the deleted electronic mail address in the destination deletion list ((corresponding to the identification portion)). In this example, since the electronic mail address “hanako@server2.fujitsu.co.jp” of the terminal apparatus T3 includes the domain name “fujitsu.co.jp” indicating the transmission available area, by the loop processing of step S108 through step S112, it remains in the destination list. On the other hand, since the electronic mail address “saburo@mail.hokano.co.jp” of the terminal apparatus T5 does not include the domain name “fujitsu.co.jp”, it is deleted from the destination list and registered in the destination deletion list.

In step S113, the CPU 22 modifies the header information of the reply mail based on the registered contents of the destination list. That is, the CPU 22 deletes the electronic mail address deleted from the destination list from the header information of the reply mail. Thereafter, the processing moves to step S114. In this example, since the electronic mail address “saburou@mail.hokano.co.jp” of the terminal apparatus T5 is delete from the destination list, the electronic mail address of the terminal apparatus 5 is deleted from the header information. That is, the row of “Cc:saburou@mail.hokano.co.jp” is deleted from the mail data shown in FIG. 8.

In step S114, the CPU 22 transmits the reply mail to the destination included in the header of the reply mail ((corresponding to the transmission portion)), and advances the processing to step S115. In this example, the mail data of the reply mail is transmitted to the mail server S2 in accordance with the electronic mail address “hokano@server2.fujitsu.co.jp” of the terminal apparatus T3. On the other hand, since the electronic mail address of the terminal apparatus T5 is deleted from the header, the mail data of the reply mail is not transmitted to the terminal apparatus T5.

In step S115, the CPU 22 determines whether or not the number of items of the destination deletion list is zero and, if it is (step S115; Y), advances the processing to step S116, and, if it is not, completes the processing after transmitting a transmission complete notice of the reply mail to the terminal apparatus T1. Thereafter, the processing moves to step S118.

In step S116, the CPU 22 takes out the electronic mail address to which the reply mail was not transmitted from the destination deletion list, and transmits a transmission complete notice of the reply mail including this electronic mail address to the terminal apparatus T1 ((corresponding to the notification portion)), and completes the processing. Thereafter, the processing moves to step S118. In this example, the electronic mail address “saburou@mail.hokano.co.jp” of the terminal apparatus T5 is taken out from the destination deletion list, and a transmission complete notice including the electronic mail address is transmitted to terminal apparatus T1.

On the other hand, when the processing moves to step S117, the CPU 22 assumes that a destination is not limited, and the reply mail is transmitted to each electronic mail address included in the header of the reply mail.

In step S118, the terminal apparatus T1 receives the transmission complete notice from the mail server S1. At this point, if the electronic mail address taken out from the destination deletion list is not included in the transmission complete notice, the CPU 2 does not specifically perform any processing. However, the CPU 2 may display the electronic mail address to which the reply mail is transferred from the mail server S1 and the fact that the reply mail was transmitted to this address on the display 14. On the other hand, if the electronic mail address is included in the transmission complete notice, the CPU 2 displays the fact that reply mail was not transmitted to the electronic mail address on the display 14. For example, the CPU 2 displays the character string indicating “the mail was not transmitted to the following address→saburou@mail.hokano.co.jp” on the display 14. In this way, the user can know that the reply mail was not transmitted to the destination outside the transmission available area (in this example, “saburou@mail.hokano.co.jp”).

Incidentally, when receiving the reply mail from the mail server S1 in accordance with the electronic mail address of the terminal apparatus T3 included in the header of the reply mail, the mail server S2 determines that the mail server S2 itself keeps the reply mail, and keeps it in a predetermined area (a mailbox) of the HDD 25. Thereafter, if a receiving request in accordance with a protocol of a POP 3 or an IMAP 4 is sent from the terminal apparatus T3, the mail server S2 takes out the reply mail from the HDD 25 and transmit it to the terminal apparatus T3. In this way, a user of the terminal apparatus T3 can refer to the reply mail. The electronic mail address “saburou@mail.hokano.co.jp” of the destination designated in the terminal apparatus T1 is deleted from the header of the reply mail.

Further, although the operations in the case in which the mail server S1 functions as a relay server of the reply mail is described in the above-mentioned operational example, if the mail server S1 receives mail data with the mail server S1 as a destination (for example, if it receives an electronic mail addressed to the terminal apparatus T2 from the terminal apparatus T1), the mail server S1 executes processing for keeping the electronic mail in an appropriate mail box in the HDD 25 instead of the processing of step S114 or step S117, or together with these processings.

In addition, although the example in which one domain name “fujitsu.co.jp” is designated as a transmission available area is described in the above-mentioned operational example, a plurality of domain names can be designated as transmission available areas. For example, in an example of display of the registration window 52 shown in FIG. 5, the first limited reply button 49 and the second limited reply button 50 are allocated to the two domain names, “1st.dept.div.fujitsu.co.jp” and “3rd.dept.div.fujitsu.co.jp”.

When such an electronic mail for which limitation of a transmission available area is designated is transmitted, destination limiting information in which a plurality of domain names are coupled by semicolons (;) such as “X-AreaLimitation:1st.dept.div.fujitsu.co.jp;2nd.dept.div.fujits u.co.jp” is embedded in the header of the electronic mail, and the mail is sent to the mail server. Then, in the mail server, whether or not an electronic mail address to be compared includes any domain name indicating the transmission available area is determined in step S108 shown in FIG. 7. In this way, whether or not the electronic mail address exists in the transmission available area is determined.

<Operation of the First Embodiment>

According to the electronic mail system of the first embodiment, the destination limiting information is added to the header in the terminal apparatus (the mail client), and the mail server limits the transmission area of an electronic mail to the transmission available area. Thus, even if a user erroneously designates a destination of an electronic mail, transmission of the electronic mail to the wrong destination is prevented. This effect can be enjoyed with any of the “new preparation” mode or the “reply (including transfer)” mode. Particularly, in the “reply” mode, since a destination is automatically designated, mail data including a destination to which an electronic mail should not be transmitted may be transmitted due to a user's error in confirming destinations. According to the first embodiment, even if such an error arises, transmission of an electronic mail to the destination can be prevented. Thus, if an electronic mail includes information that should be kept secret such as intra-office information, the confidentiality of the information can be maintained by limiting a transmission area. In the above-mentioned example, erroneous leakage of information that should spread only within the company A (the network N1) to the company B (the network N2) can be prevented. In addition, if a part of a domain name (for example, a server name) is different even in the same company, a transmission area can be limited. Thus, for example, if a mail server is prepared for each department of a company, a specific department alone can be set as a transmission available area.

In addition, according to the first embodiment, the electronic mail is transmitted only to the destinations within the transmission available area among the displayed destinations irrespective of the contents of the destinations displayed in the mail edit window 60. Thus, when the electronic mail is transmitted with the “reply” mode, if all the destinations to which the electronic mail should be sent are included in the destinations displayed in the mail edit window 60 by the initial setting, the user does not need to delete unnecessary destinations from the destinations. In this way, a user's labor can be reduced in designating destinations in the “reply mode”.

Further, in the first embodiment, the configuration is adopted in which a domain name is included in the header as the destination limiting information. However, information other than a domain name can be used as the destination limiting information if the information can identify a single or a plurality of destinations included in the header of the electronic mail into those within the transmission available area and those outside the transmission available area. In other words, conditions for limiting destinations do not have to be domain names.

In addition, in the first embodiment, the mail server S1 executes the processing for limiting the transmission area of an electronic mail to the transmission available area based on the destination limiting information (the processing of step S104 to step S114). Instead of this configuration, it is possible to configure, for example, such that the above-mentioned processing is executed by the terminal apparatuses T1 through T4 or the mail server S4 in the Internet IN.

In addition, if the present invention is applied to a mail client, other than the computer explained as terminal apparatuses T1 to T4, it can be also applied to electronic equipment that is capable of functioning as a mail client (i.e., provided with a processor and a memory for executing a mailer) such as a cellular phone, a video game machine, AV equipment (a television, a video player, etc.), a terminal apparatus of a car navigation system.

[Second Embodiment]

An electronic mail system of a second embodiment of the present invention will now be described. Since a network configuration as well as a hardware configuration of a terminal apparatus and a mail server of the second embodiment are the same as those shown in FIG. 1 through 3, description of the configurations are omitted. However, the second embodiment has different processing in the terminal apparatus and the mail server.

<Operational Examples of the Second Embodiment>

Processing in the terminal apparatus and the mail server will be hereinafter described by describing operational examples of the electronic mail system. As an operational example of the second embodiment, operations in the case in which a terminal apparatus T1 transmits a reply mail with each of terminal apparatuses T3 and T5 designated as “TO” and a terminal apparatus T4 designated as “CC” in response to a received mail from the terminal apparatus T5 is described.

In this example, an electronic mail address of the terminal apparatus 1 is “taro@server1.fujitsu.co.jp”, an electronic mail address of the terminal apparatus T3 is “hanako@server2.fujitsu.co.jp”, an electronic mail address of the terminal apparatus T4 is “jiro@server2.fujitus.co.jp”, and an electronic mail address of the terminal apparatus T5 is “saburou@mail.hokano.co. jp”.

In addition, a transmission available area can be also designated using a registration window 52 in the second embodiment as in the first embodiment, its contents are reflected in a mail edit window 60. In the following operational example, it is assumed that a domain name “fujitsu.co.jp” is designated as the transmission available area in advance by a user, and a first limited reply button 49 is allocated to the domain name.

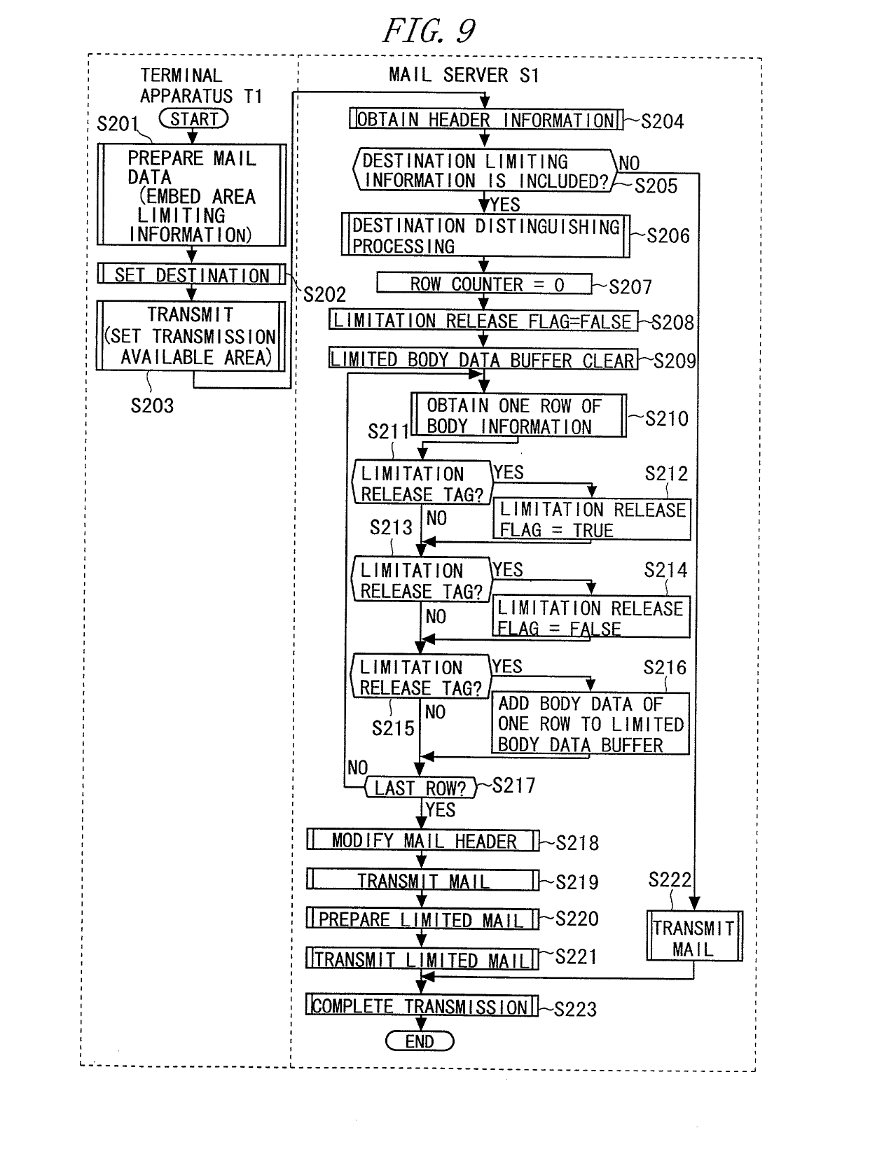

FIG. 9 is a flow chart showing processing of a CPU 2 of the terminal apparatus T1 and a CPU 22 of a mail server S1 according to the second embodiment. In step S201, the CPU 2 of the terminal apparatus T1 displays a main window 40 (see FIG. 4) on a display 14 in accordance with an instruction of the user. In this main window 40, a received mail for which a reply mail should be transmitted is designated, and when the first limited reply button 49 is pressed, the CPU 2 displays the mail edit window 60 corresponding to the first limited reply button 49 on the display 14.

The user prepares a body of the reply mail to the received mail using the mail edit window 60. At this point, the user performs the following setting if the user wishes to transmit a part of the body of the reply mail to a destination outside the company.

That is, a limitation release tag “<arealimitation all>” is entered in a row immediately preceding a row on which a sentence corresponding to the part of the body to be sent to outside the company out of the body. Subsequently, a limitation reset tag </arealimitation>” is entered in a row next to a row on which the sentence ends. In this way, the user designates the area by sandwiching the part to be sent to outside the company by the limitation release tag and the limitation reset tag. A pair of pieces of information consisting of the limitation release tag and the limitation reset tag are hereinafter referred to area designation information.

Then, the user designates destinations using each of address input columns 61 to 63 (step S202). That is, the user sets the destinations in a state in which an electronic mail address “hanako@server2.fujitsu.co.jp;saburo@mail.hokano.co.jp” of the terminal apparatuses T3 and T5 is displayed in an address input column 61 (a designated column of “TO”), and an electronic mail address “jiro@server2.fujitsu.co.jp” of the terminal apparatus 4 is displayed in an address input column 62 (a designated column of “CC”).

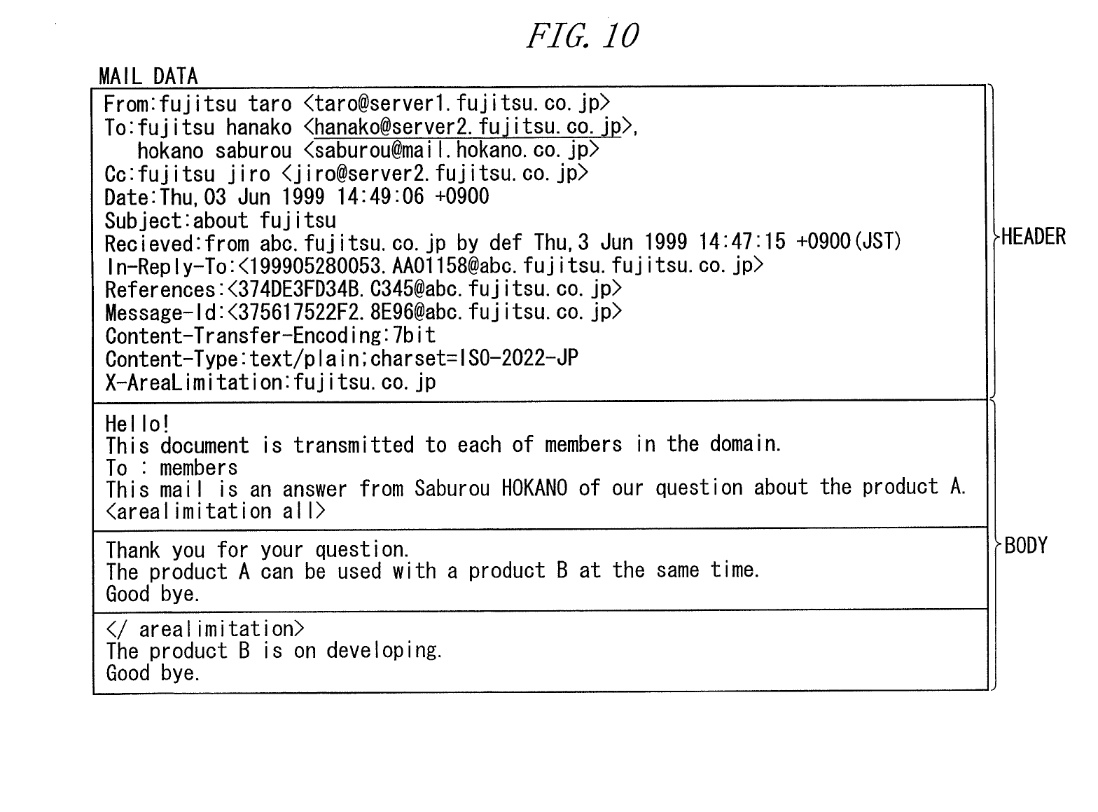

Thereafter, when the user presses a transmission button 67 in a state in which a transmission available area “fujitsu.co.jp” is designated (a state in which a check mark is entered in a check column 66 of the mail edit window 60), the CPU 2 executes transmission processing of mail data of the reply mail, and prepares mail data having a header and a body shown in FIG. 10 ((corresponding to a preparation portion, a first information adding portion and a second information adding portion)). That is, the CPU 2 prepares a mail data with destination limiting information of “X-Arealimitation:fujitsu.co.jp” added to the header by the designation of the destination available area, and area designation information inputted by the user added to the body, and transmits the mail data to the mail server S1 in accordance with the SMTP ((corresponding to a transmission portion)).

The mail server S1, upon receiving the mail data from the terminal apparatus T1, executes the following processing. That is, the CPU 22 obtains header information from the mail data in step S204, and advances the processing to step S205.

In step S205, the CPU 22 determines whether or not the destination limiting information is included in the header information ((corresponding to a determination portion)), and if it is not, advances the processing to step S222, and if it is, advances the processing to step S206.

In step S206, the CPU 22 executes destination dividing processing (destination distinguishing processing). That is, the CPU 22 executes the processing of step S105 through step S112 described in the first embodiment. Since the detailed processing has already been described, it is omitted here. In this way, a plurality of destinations (electronic mail addresses) included in the mail data is distinguished as to whether they belong to a first area or a second area. That is, the plurality of destinations is divided (distinguished) into those within the transmission available area ((corresponding to the first area)) and those outside the transmission available area ((corresponding to the second area)), the electronic mail addresses within the transmission available area are held in the destination list described in the first embodiment, and the electronic mail addresses outside the transmission available area are held in the destination deletion list described in the first embodiment. In this example, the electronic mail addresses of the terminal apparatuses T3 and T4 are held in the destination list, and the electronic mail address of the terminal apparatus T5 is held in the destination deletion list. Thereafter, the processing moves on to step S207.

In step S207, the CPU 22 sets a row counter prepared, for example, on an RAM 24 to zero, and advances the processing to step S208.

In step S208, after setting a state of a release limiting flag prepared, for example on the RAM 24 as “FALSE”, the CPU 22 advances the processing to step S209.

In step S209, the CPU 22 clears a limited body data buffer prepared, for example, on the RAM 24, and then advances the processing to step S210.

In step S210, the CPU 22 obtains information of the body of the reply mail for one row in order from the top. Then, the process moves to step S211.

In step S211, the CPU 22 determines whether or not the information of the body obtained in step S210 is a limitation release tag “arealimitation all”. At this point, if the information of the body is the limitation release tag, the processing moves to step S212, and if not, the processing moves to step S213.

In step S212, the CPU 22 sets the state of the limitation release flag as “TRUE”, and advances the processing to step S213.

In step S213, the CPU 22 determines whether or not the information of the body obtained in step S210 is a limitation reset tag “/arealimitation”. At this point, if the information of the body is the limitation reset tag, the processing moves to step S214, and if not, the processing moves to step S215.

In step S214, the CPU 22 sets the state of the limitation release flag as “FALSE”, and advances the processing to step S215.

In step S215, the CPU 22 determines whether or not the current state of the limitation release tag is “TRUE”. At this point, if the limitation release tag is “TRUE”, the processing moves to step S216, and if not, the processing moves to step S217.

In step S216, the CPU 22 stores body information for one row taken out in step S210 in a limited body data buffer, and advances the processing to step S217.

In step S217, the CPU 22 determines whether or not the information of the body taken out in step S210 is information of the last row of the body. At this point, if the information of the body is the information of the last row, the processing moves to step S218. On the other hand, if the information of the body is not the information of the last row, the processing returns to step S210, and loop processing of step S210 to step S217 is executed until YES is determined in the step S217.

In this way, in step S210 to step S217, the CPU 22 searches area designation information in the body (the limitation release tag and the limitation reset tag) (steps S211 and S213 (corresponding to a second determination portion)) and, if there is the area designation information, stores the part sandwiched by the limitation release tag and the limitation reset tag in the body in the limitation body data buffer ((corresponding to an extraction portion)). In the above-mentioned example, the part sandwiched by “<arealimitation all>” and “</arealimitation>” among the body in the mail data shown in FIG. 10 in a limited data buffer.

In step S218, the CPU 22 modifies the header of the mail data received from the terminal apparatus T1. That is, the CPU 22 deletes the electronic mail address deleted from the destination list from the header in accordance with the contents held in the destination list. In this example, since the electronic mail address “saburou@mail.hokano.co.jp” of the terminal apparatus T5 is deleted from the destination list, the electronic mail address is deleted from the header information. Then, the processing moves to step S219.

In step S219, the CPU 22 transmits the reply mail to the destination included in the header of the reply mail ((corresponding to the transmission portion)), and advances the processing to step S115. In this example, the mail data of the reply mail is transmitted to a mail server S2 in accordance with the electronic mail address of the terminal apparatus T3 “hanako@server2.fujitsu.co.jp” and the electronic mail address of the terminal apparatus T4 “jiro@server2.fujitsu.co.jp”. Then, the processing moves to step S220.

In step S220, the CPU 22 prepares a limited mail ((corresponding to another electronic mail)). That is, the CPU 22 replaces the electronic mail address of the destination in the header of the reply mail with the electronic mail address in the destination deletion list. Specifically, the CPU 22 deletes the electronic mail addresses of the destinations in the header except for the electronic mail addresses held in the destination deletion list. In this example, the electronic mail addresses of the terminal apparatuses T3 and T4 are deleted from the header, and only the electronic mail address of the terminal apparatus T5 remains. Further, attributes (“TO”, “CC” and “BCC”) designated in the remaining electronic mail address are unchanged. Moreover, the CPU 22 changes the contents of the body of the reply mail to the contents held in the limited body data buffer. For example, the CPU 22 deletes from the body the part other than the part held by the limited body data buffer. An electronic mail with an electronic mail address outside a transmission available area being made as a destination, and an area specified by the area designation information being made a body in this way is called a “limited mail”. Then, the processing moves to step S221.

In step S221, the CPU 22 transmits a limited mail in accordance with the destination electronic mail address in the header of the limited mail (corresponding to the transmission portion)). In this example, the electronic mail address of the terminal apparatus T5 is designated in the header of the limited mail. Thus, the limited mail is transmitted to the Internet IN. Then, the processing moves to step S223.

Incidentally, if the processing moves to step S222, the CPU 22 transfers the reply mail to each electronic mail address included in the header of the reply mail assuming that the mail data is to be transferred to all the destinations in the header. Then, the processing moves to step S223.

When the processing of step S221 or step S222 is completed, the CPU 22 prepares a transmission complete notice, and transmits it to the terminal apparatus T1. Then, in step S223, the CPU 2 displays the fact that the transmission of the reply mail is completed on the display 14.

The mail server S2, upon receiving the reply mail from the mail server S1 by the processing in the mail server S1, determines that the received reply mail is to be kept by the mail server S2 itself based on the electronic mail addresses of the terminal apparatuses T3 and T4 included in the header of the received reply mail, and keeps the received reply mail in a mail box corresponding to each electronic mail address prepared in an HDD 25. Thereafter, if the mail server S2 receives a receiving request of the reply mail in accordance with a protocol of a POP 3 or an IMAP 4 from the terminal apparatus T3 or the terminal apparatus T4, the mail server S2 takes out a reply mail corresponding to the receiving request from the HDD 25, and transmits it to the terminal apparatus T3. In this way, a user of the terminal apparatus T3 can refer to the reply mail.

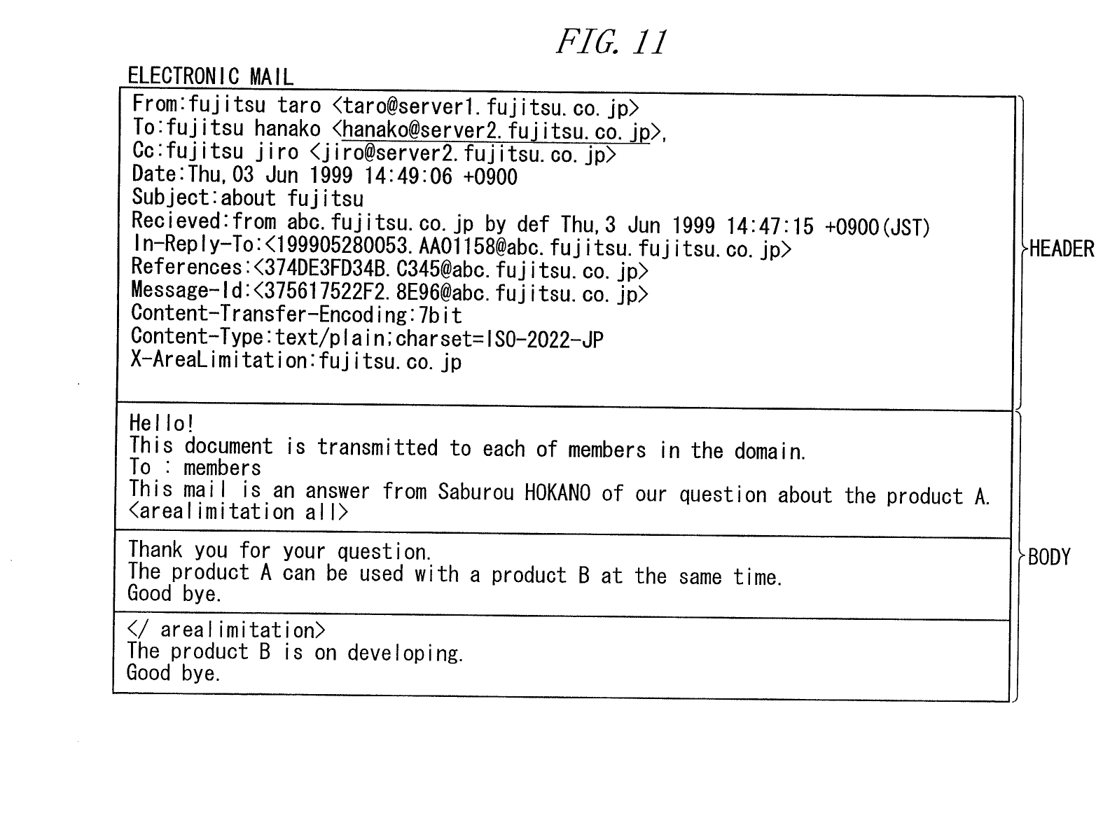

FIG. 11 is a view illustrating contents of the reply mail transmitted to the terminal apparatus T3 or the terminal apparatus T4. As shown in FIG. 11, the electronic mail address “saburou@mail.hokano.co. jp” designated in the terminal apparatus T1 is deleted from the header of the reply mail. In addition, the entire body transmitted from the terminal apparatus T1 is transmitted.

On the other hand, the limited mail transmitted to the Internet IN from themail server S1 is transferred to a mail server S3 through a router R1, a mail server S4 and a router R2. The mail server S3 keeps the limited mail in a mail box corresponding to the electronic mail address of the terminal apparatus T5 prepared in the HDD 25, and gives the limited mail to the terminal apparatus T5 in response to a request from the terminal apparatus T5.

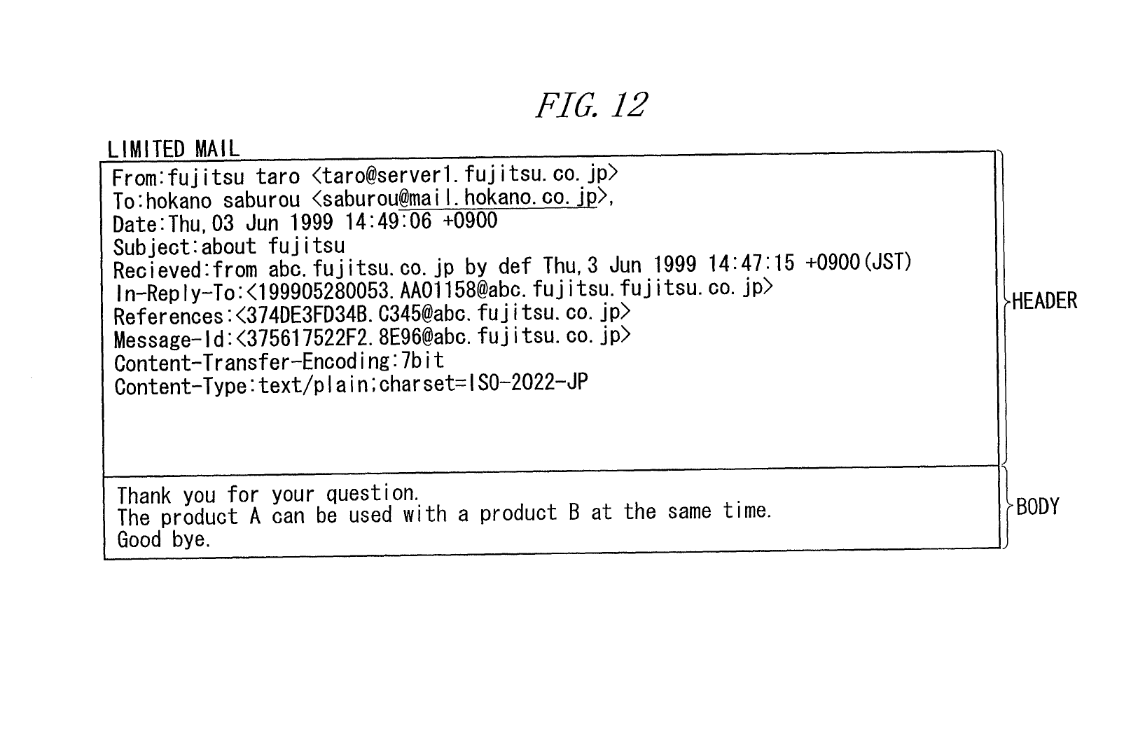

FIG. 12 is a view illustrating contents of the limited mail to be given to the terminal apparatus T5. As shown in FIG. 12, electronic mail addresses of the terminal apparatuses T3 and T4 are deleted from the header of the limited mail. In addition, only the area designated by the area designation information among the body transmitted from the terminal apparatus T1 is given as a body.

<Operation of the Second Embodiment>

According to the second embodiment, mail data including the destination limiting information and the area designation information are prepared in the terminal apparatus (the mail client) and transmitted to the mail server. Then, the mail server divides the destinations of the header to the destinations within the transmission available area ((corresponding to the destinations belonging to the first area)) and the destinations outside the transmission available area ((corresponding to the destinations belonging to the second area)), transmits the entire body received from the terminal apparatus to the destinations within the transmission available area, and transmits the limited mail having only the part designated by the area designation information out of the body received from the terminal apparatus as a body.

In this way, there are the following advantages. For example, a case in which a user of the terminal apparatus T1 of the company A has to transmit certain information to others in the company A and to the company B is assumed. In this case, if there are an internal (intra-office) comment (information that is not desired to be released outside) and an external (for the company B) comment, a user would have had to perform the following processing with a conventional mailer. That is, the user has to transmit an electronic mail including the internal comment to others in the company, and at the same time, has to transmit an electronic mail including the external comment to the company B. In this way, with the conventional mailer, the user has to transmit two electronic mails with different contents in the bodies by separate sorts of transmission processing in the above-mentioned case.

On the other hand, according to the second embodiment, if a body is prepared in a form including an internal part and an external part, and the external part is designated by the area designation information, an electronic mail including the body can be transmitted by a single transmission processing with the electronic mail addresses in the company (within the transmission available area) and the electronic mail address of the company B (outside the transmission available area).

Therefore, since processing for transmitting an electronic mail by the user may be. just once (the number of times for instructing transmission may be once), exertion of the user (effort required for preparing a body and effort required for transmitting an electronic mail) can be reduced.

In addition, since the user does not need to prepare a body by separating it into an internal body and an external body, the number of transmission mails (the number of transmission documents) can be reduced, and the management is made easier.

As described above, according to the first and the second embodiments, careless leakage of information in transmitting an external electronic mail can be prevented, and at the same time, external information and internal information can be managed unitarily and efficiently.

Further, the processing of step S205 through step S221 in the mail server S1 in the second embodiment can be configured such that it is executed in the mail server S4 in the Internet IN.

In addition, the first embodiment and the second embodiment can be combined. In this case, by providing after the step S205 shown in FIG. 9, a determination step for determining whether or not there is area designation information in the body, in a case where there is no area designation information, the processing of step S106 through step S118 shown in FIG. 7 is executed, and in case where there is the area designation information, the processing moves to step S206.

In addition, although the second embodiment is described concerning the example in which the destinations in the header are determined whether they belong to the first area or the second area, a plurality of (three or more) areas including the first area and the second area may be prepared and determination may be made on which of the plurality of areas the destinations belong to.

[Third Embodiment]

An electronic mail system according to a third embodiment of the present invention will now be described. Since a network configuration and a hardware configuration of a terminal apparatus and a mail server of the third embodiment are the same as those shown in FIGS. 1 to 3, description of the configurations is omitted. However, in the third embodiment, if destination limiting information is not included in the header of the mail data in the mail server, transmission processing is performed after the mail server holds the mail data for a predetermined period.

<Operational Examples of the Third Embodiment>

Processing of the terminal apparatus and the mail server will now be described by describing operational examples of the electronic mail system of the third embodiment. However, the third embodiment includes the same parts as those of the first embodiment, therefore description is omitted for the same parts and only the different parts will be described.

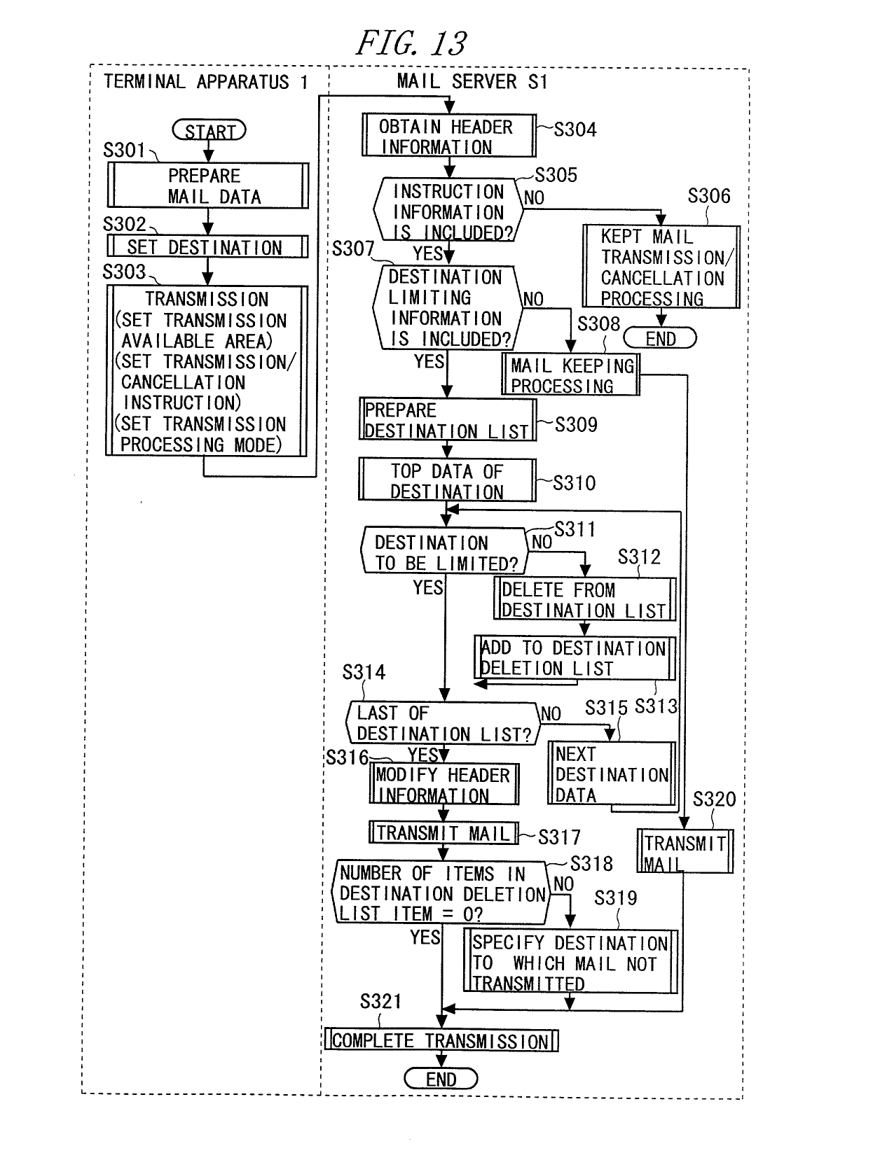

FIG. 13 is a flow chart showing processing of a CPU 2 of a terminal apparatus T1 and a CPU 22 of a mail server S1 according to the third embodiment. In the flow chart shown in FIG. 13, new steps (step S305 and step S306) are inserted between step S104 and step S106 as well as a new step (step S308) is inserted between steps S105 and step S117 of the flow chart of the first embodiment respectively.

In addition, step S301 to step S303 are slightly different from step S101 through step S103 of the first embodiment to which the steps correspond. In other steps, the same processing as in the corresponding steps in the first embodiment is executed. The above-mentioned steps will be hereinafter described concerning the following operational examples.

<Operational example 1>A case in which a user immediately transmits electronic mail

<Operational example 2>A case in which a user temporarily keeps an electronic mail

<Operational example 3>A case in which a user forcibly transmits an electronic mail that is temporarily kept

<Operational example 4>A case in which a user cancels transmission of an electronic mail that is temporarily kept

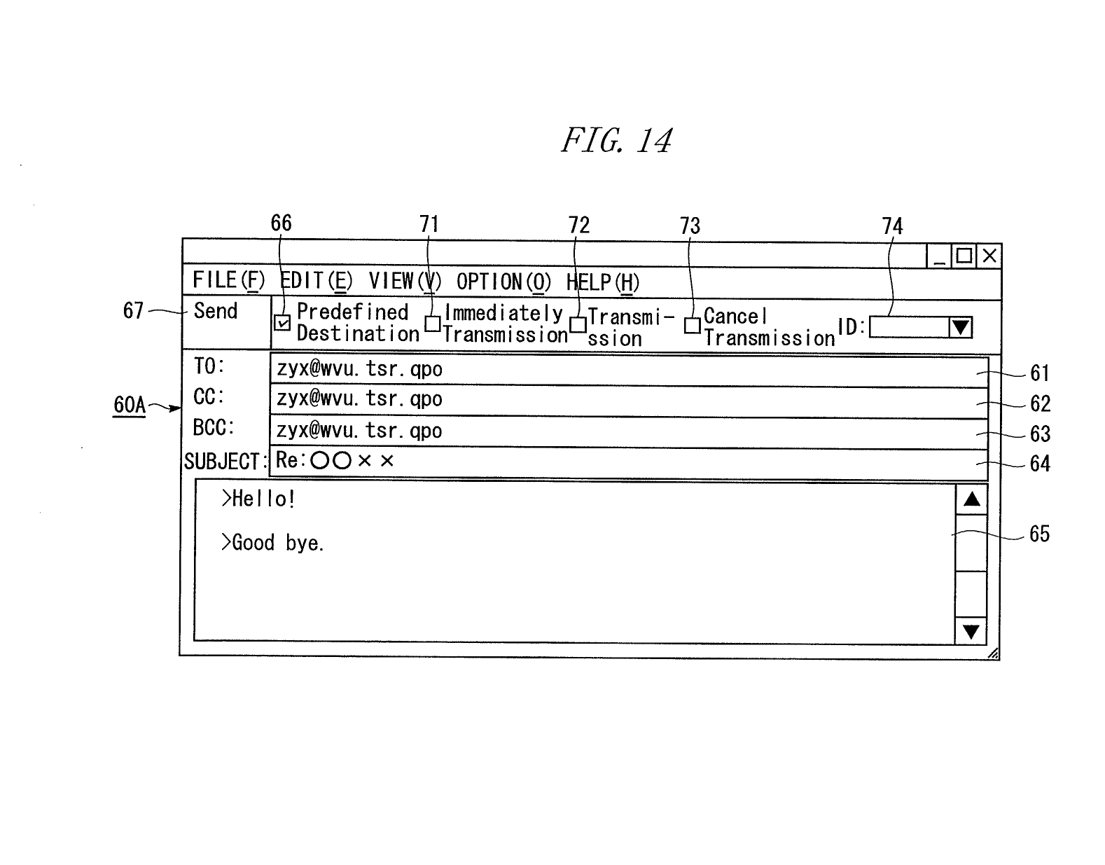

In executing the above-mentioned operational examples 1 through 4, a mail edit window as shown in FIG. 14 is used by executing a mailer in a mail client (the terminal apparatus T1) in the third embodiment.

FIG. 14 is a view illustrating a display example of a mail edit window 60A in the third embodiment. The mail edit window 60A is provided with check columns 71 through 73 and a mail ID input column in addition to the contents of the mail edit window 60 shown in FIG. 6.

The check column 71 is the column for designating whether or not an electronic mail received by the mail server is to be transmitted immediately or to be transmitted after being kept for a predetermined period, in a case in which a user transmits an electronic mail whose transmission area is not limited to the mail server. In this example, the electronic mail received by the mail server is immediately transmitted if a check mark is entered in the check column 71, and the electronic mail received by the mail server is transmitted after being kept for a predetermined period if the check mark is not entered.

The check column 72 is the column for designating whether or not a user gives the mail server a forcible instruction to transmit a kept electronic mail to another mail server in a case in which an electronic mail whose transmission area is not limited is kept in the mail server. The check column 72 is checked if the user forcibly transmits the electronic mail kept in the mail server. The mail server forcibly (before a predetermined time elapses) transmits the kept electronic mail to another mail server if it receives an electronic mail including a forcible instruction.

The check column 73 is the column for designating whether or not transmission of a kept electronic mail to another mail server is to be canceled, in a case in which an electronic mail whose transmission area is not limited is kept in the mail server. The check column 73 is checked if the user cancels the transmission of the electronic mail kept in the mail server. The mail server does not transmit the kept electronic mail to another mail server if it receives an electronic mail including a cancellation instruction.

The message ID input column is the column for inputting a message ID of an electronic mail temporarily kept in the mail server.

Further, at the time when the mail edit window 60A is displayed, each of the check columns 66 and 71 through 74 is in an input available state. Thereafter, when the check column 71 is checked, other check columns 66, 72 and 73 as well as the message ID input column 74 are in an input unavailable state. On the other hand, if the check column 72 or the check column 73 is checked, the other check columns are in the input unavailable state, but the message ID input column 74 keeps the input available state.

<Operational Example 1>

In a case in which a user immediately transmits an electronic mail whose transmission area is not limited, the user inputs a body using the mail edit window 60A displayed by the CPU 2 in step S301, designates a destination (step S302), and checks the check column 71. Thereafter, when the user presses a transmission button 67, the CPU 2 transmits the mail data to the mail server SI by substantially the same processing as that in the first embodiment. The header of the mail data to be transmitted at this point has the following row reflecting a check result of the check column 71 inserted in its last row.

“X-transfertype:1”

Here, “X-transfertype” is an identifier indicating a transmission type of an electronic mail, and the part “:1” indicates the type. The type consists of the above-mentioned “1:immediately transmit” and “0:transmit after keeping for a predetermined time”. If the check column 71 is checked, “1” is set, and, if any of the check columns 66 and 71 to 73 is not checked, “0” is set. In this example, since the check column 71 is checked, “1” is set.

Thereafter, upon receiving the mail data, the mail server S1 advances the processing to step S308, after determining “NO” in step S307. In step S308, the CPU 22 executes mail keeping processing.

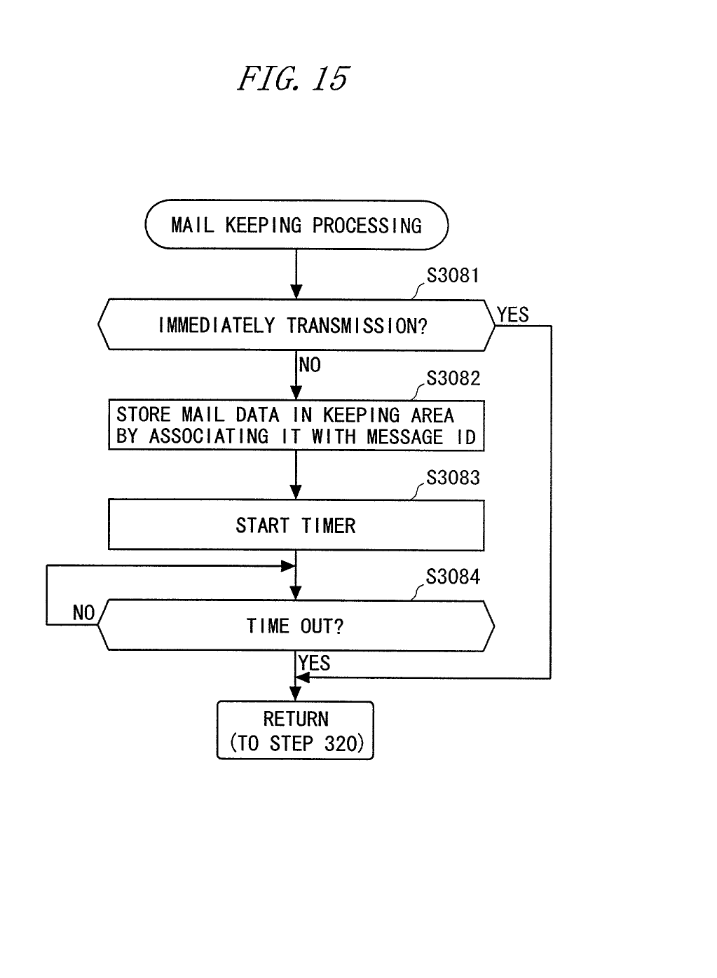

FIG. 15 is a flow chart showing the mail keeping processing. In step S3081, the CPU 22 determines whether or not the type of “X-transfertype” included in the header of the mail data is “1:immediately transmit”. In this example, since the type is “1”, the mail keeping processing is completed, and the processing moves to step S320 shown in FIG. 13.

In step S320, the same processing as step S117 in the first embodiment is executed, and the mail data is transmitted to each destination included in the header.

<Operational Example 2>

If the user wishes to keep an electronic mail whose transmission area is not limited in the mail server for a predetermined period, the user presses the transmission button 67 in a state in which each of the check columns 66 and 71 through 73 is not checked in step S301 and step S302. Then, the CPU 2 transmits mail data with “X-transfertype:0” inserted in the last row of the header to the mail server S1 in step S303.

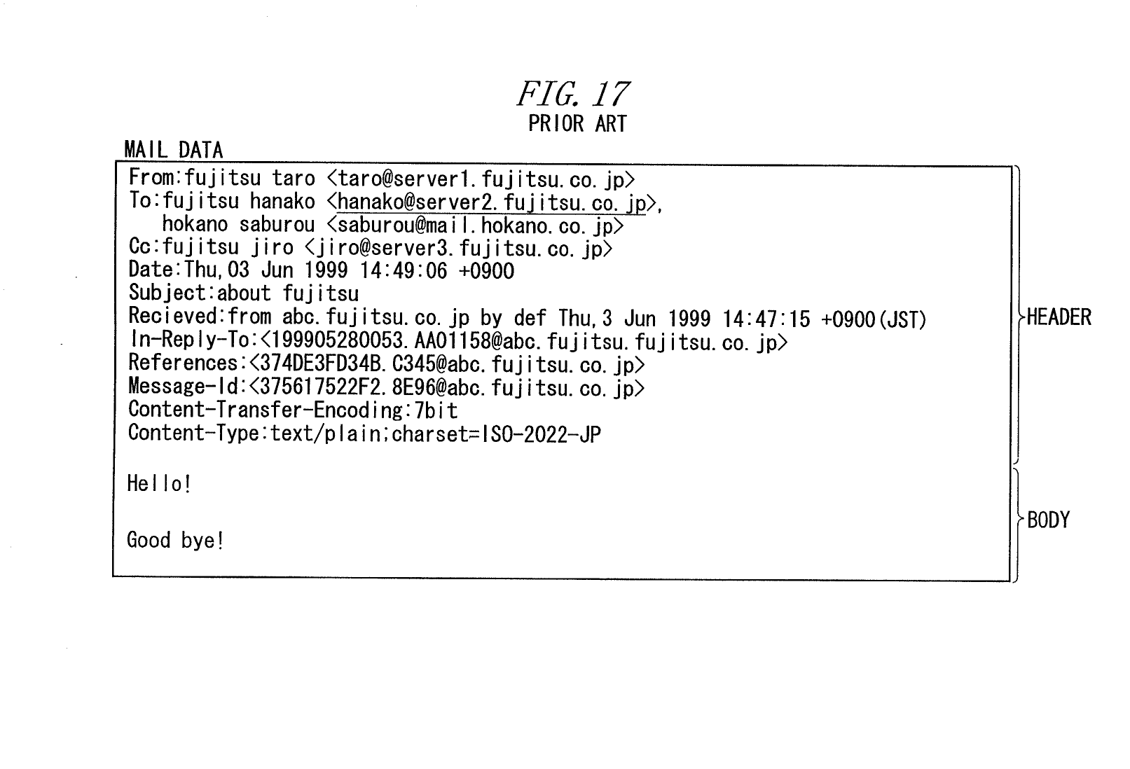

In addition, the CPU 2 keeps the message ID allocated to the header in step S303 in a predetermined area, and at the same time displays it on a display 14. Here, the message ID is a unique identification information that is necessarily allocated to a header of an electronic mail to be transmitted by the mail client (FIG. 17). The message ID is used for the mail server to identify a received mail.

Thereafter, upon receiving the mail data, the mail server S1 advances the processing to step S308 after determining “NO” in step S307. In step S308, the CPU 22 executes the mail keeping processing shown in FIG. 15.

In the operational example 2, since the type of “X-transfertype” included in the header of the mail data is set in “1:transmit after a predetermined time elapses”, the CPU 22 determines “NO” in step S3801, and the processing moves to step S3802.

In step S3802, the CPU 22 stores the mail data in a storing area prepared in advance in an RAM 24 or an RAM 25 while associating it with the message ID ((corresponding to a keeping portion)), and advances the processing to step S3803.

In step S3803, the CPU 22 starts a timer (not shown) for measuring keeping time of the mail data. The timer is time-out when a predetermined time, which is a keeping period set by a user of the terminal apparatus T1 or an administrator of the mail server, elapses.

Thereafter, in step S3804, when the CPU 22 detects the time-out of the timer, the processing returns to step S320, and transmission processing for the mail data stored in the keeping area is executed ((corresponding to the transmission portion)).

Further, in actual processing, upon starting the timer in step S3803, the CPU 22 shifts to processing for another received mail, and executes the processing of step S320 by interrupt processing with the time-out of the timer as a trigger.

<Operational Example 3>

As described concerning the operational example 2, since the mail data is kept in the mail server S1 for the predetermined period, the user can confirm whether or not a destination of the transmitted electronic mail is correct during the period. The confirmation job is performed by the user referring to an electronic mail address of the destination included in a transmission history that the CPU 2 automatically holds in the HDD 5 by the processing of step S303. At this point, if the user wishes to transmit the mail data kept in the mail server S1 before the keeping time elapses based on a confirmation result that the destination is correct, the user prepares a dummy electronic mail for instructing transmission (forcible transmission) of the mail data to the mail server S1.

That is, the user checks the check column 72 of the mail edit window 60A displayed in step S301, and at the same time, inputs a message ID of mail data that the user desires to transmit in the message ID input column 74. Subsequently, the user designate a destination of the electronic mail in step S302. At this point, the user can set an arbitrary destination because the electronic mail is a dummy. Thereafter, when the user presses the transmission button 67, the CPU 22 inserts the following row as designation information reflecting the check result of the check column 72 in the last row of the header.

“instruction:message ID;instruction type (0 or 1)”

Here, “instruction” in the above-mentioned row is an identifier indicating an instruction of processing to the electronic mail kept in the mail server S1, and the “message ID” is used as specifying information of the kept electronic mail. The instruction type indicates instruction contents; for example, if the instruction contents is transmission (forcible transmission) of the kept electronic mail, “0” is set, and, if the instruction contents is transmission cancellation of the kept electronic mail, “1” is set. In this example, “0” is set.

The CPU 2 transmits mail data having a header including such instruction information to the mail server S1 from the terminal apparatus T1. In the mail server S1, when the mail data is received, the CPU 22 obtains the header information in step S304, detects the designation instruction information in step S305, and advances the processing to step S306.

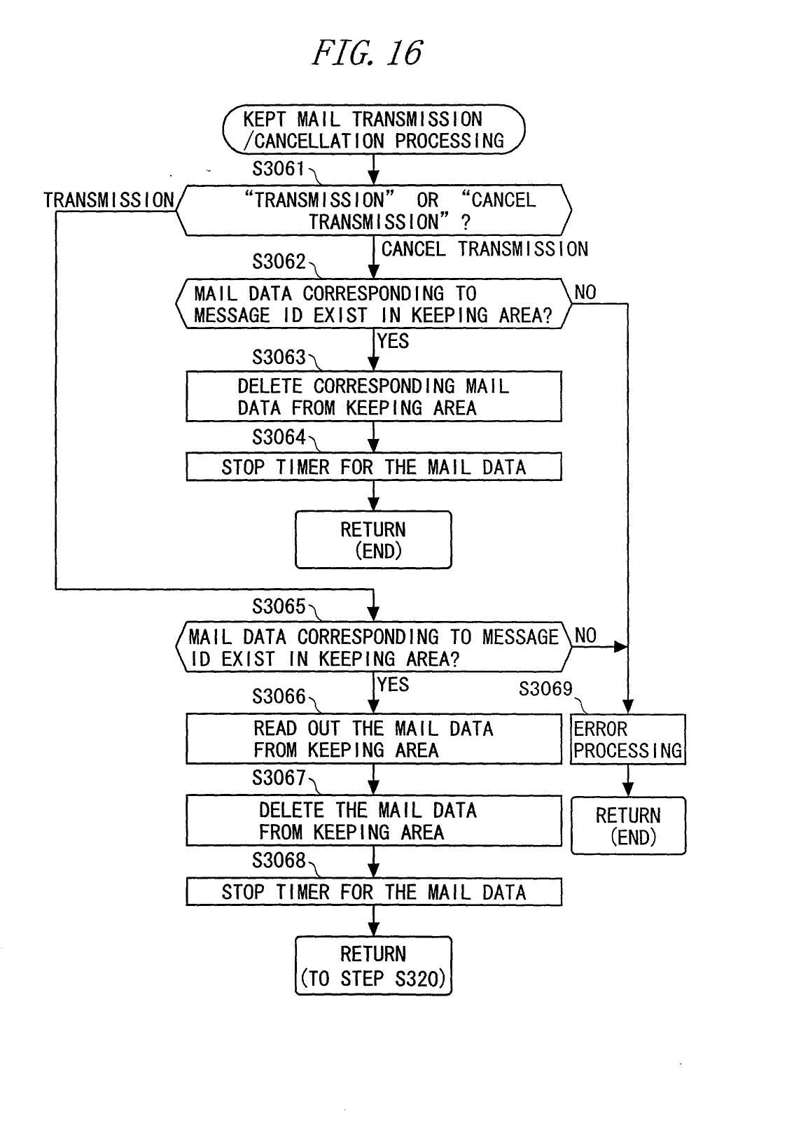

In step S306, the CPU 22 executes kept mail transmission/cancellation processing. FIG. 16 is a flow chart describing the kept mail transmission/cancellation processing. In step S3061, the CPU 22 determines whether the instruction is “transmission” or “transmission cancellation” by distinguishing an instruction type in the instruction information. In this example, since “0 (transmission)” is set as the instruction type, the CPU 22 advances the processing to step S3065.

In step S3065, the CPU 22 determines whether or not mail data corresponding to the message ID in the instruction information is stored in the keeping area. At this point, if the mail data is stored, the processing moves to step S3066 and, if it is not, the processing moves to step S3069.

In step S3066, the CPU 22 reads out the mail data corresponding to the message ID from the keeping area. Subsequently, the CPU 22 deletes the mail data from the keeping area (step S3067), and stops a timer for the mail data (step S3068).

Thereafter, the CPU 22 advances the processing to step S320 of FIG. 13, and executes transmission processing of the mail data read out from the keeping area by interrupt processing. In this way, the mail data temporarily kept in the mail server S1 is forcibly transmitted to its destination before the keeping time elapses. However, if the destination of the mail data is the mail server S1, the CPU 22 keeps the mail data read out from the keeping area in a mail box corresponding to the destination.

Such forcible transmission is effective when a user who have transmitted an electronic mail to which temporary keeping by the mail server S1 is set wishes to transmit the electronic mail from the mail server S1 immediately after confirming a destination of the electronic mail.

<Operational Example 4>

If the user of the terminal apparatus T1 performs confirmation job with respect to the mail data of the electronic mail temporarily kept in the mail server S1, and as a result, desires transmission cancellation of the kept mail data, the user prepares a dummy electronic mail for instructing the transmission cancellation of the mail data to the mail server S1.

That is, the user checks the check column 73 of the mail edit window 60A displayed in step S301, and at the same time, inputs a message ID of the mail data the user desires to cancel transmission in the message ID input column 74. Subsequently, the user designates a destination of the dummy electronic mail in step S302.

Thereafter, when the transmission button 67 is pressed, the CPU 22 inserts the following row as instruction information reflecting the check result of the check column 72 in the last row of the header.

“instruction:message ID;instruction type (1)”

Then, the CPU 2 transmits mail data having a header including the instruction information from the terminal apparatus T1 to the mail server S1. In the mail server S1, when the mail data is received, the CPU 22 obtains header information in step S304, detects the instruction information in step S305, and advances the processing to step S306.

In step S306, the CPU 22 executes the kept mail transmission/cancellation processing shown in FIG. 16. In this example, the CPU 22 determines that the instruction is transmission cancellation in step S3061 because the transmission type of the instruction information is “1”, and advances the processing to step S3062.

In step S3062, the CPU 22 determines whether or not mail data corresponding to the message ID in the instruction information are stored in the keeping area. At this point, if the mail data is stored, the processing moves to step S3063, and if it is not, the processing moves to step S3069.

In step S3063, the CPU 22 deletes the mail data corresponding to the message ID from the keeping area, and stops a timer for the mail data (step S3064). Then, the CPU 22 completes the processing. In this way, the CPU 22 prevents the mail data corresponding to the transmission cancellation from being transmitted from the mail server S1 ((corresponding to a cancellation portion)).

In this way, the user of the terminal apparatus T1 can cancel transmission of the electronic mail temporarily kept in the mail server S1 by transmitting the electronic mail for transmission cancellation depending on circumstances of an error of the destination and the like.

Further, if it is determined in step S3061 and step S3065 that the mail data corresponding to the message ID do not exist in the keeping area, error processing is executed in step S3069. That is, the CPU 22 transmits an error notice including the message ID and an error signal to the terminal apparatus T1 as the error processing. Then, the CPU 2 of the terminal apparatus T1 displays, for example, the following representation on the display 14 based on the error notice.

“error:

a mail having the following message ID seems to have already been transmitted, a designated message ID is wrong.”

In this way, the user of the terminal apparatus T1 can notice an error of the designated message ID. In addition, the user can request to the destination, disposal and the like of the mail assuming that the mail data has already been transmitted to a wrong destination.

Further, the electronic mail having the header including the instruction information is a dummy electronic mail for giving an instruction to the mail sever S1, and its body and destination are dummies for not being determined as an error in transmission contents check by the mailer. Thus, the mail data including the instruction information is disposed of by the CPU 22 after the kept mail transmission/cancellation processing is completed. Further, the instruction information may be arranged such that the information is set in a body, the mail server S1 detects the instruction information from the body, and the kept mail transmission/cancellation processing is executed.

According to the third embodiment described above, the mail data in which the destination limiting information is not included is temporarily kept in the mail server S1, and transmission of the mail data can be canceled by instructing transmission cancellation during the period.

In this way, after the user of the terminal apparatus T1 inputs transmission instruction of an electronic mail (after the transmission button 67 is pressed), transmission of the electronic mail can be canceled. In this way, even if a transmission available area is not designated, transmission of the electronic mail to a wrong destination can be prevented.

Further, the processing in the mail server S1 (the processing of step S305 through step S320) described in the third embodiment can be configured such that the processing is executed in the terminal apparatuses T1 through T4 and the mail server S4 in the Internet IN. In addition, the configuration described concerning the third embodiment can be combined with the configuration described in the second embodiment.

Further, although the example is described in which the mail keeping processing and the kept mail transmission/cancellation processing are executed with an electronic mail including destination limiting information as an object, and determination on existence of the destination limiting information as a premise, the mail keeping processing and the kept mail transmission/cancellation processing can also be applied to an electronic mail not including the destination limiting information (a conventional electronic mail) that is planned to be transmitted from a mail client and a mail server. That is, the mail client and the mail server described concerning the third embodiment may be configured such that the mail keeping processing and the kept mail transmission/cancellation processing are executed in a mail client and a mail sever that do not have configuration for destination limiting information.

This invention being thus described, it will be obvious that same may be varied in various ways. Such variations are not to be regarded as departure from the spirit and scope of the invention, and all such modifications would be obvious for one skilled in the art intended to be included within the scope of the following claims.

What is claimed is:

1. An electronic mail system comprising:
a determination portion determining whether or not destination limiting information is included in an electronic mail that is planned to be transmitted;
an identification portion identifying whether or not said electronic mail should be transmitted to destinations included in a header of said electronic mail based on destination limiting information if it is determined by said determination portion that the destination limiting information is included; and
a transmission portion transmitting said electronic mail only to a destination that is identified by said identification portion as a destination to which said electronic mail should be transmitted.

2. An electronic mail system according to claim 1, wherein said destination limiting information includes specific information of area to which said electronic mail should be transmitted;
said identification portion identifies a destination coinciding with said specific information of area among the destinations included in said header as a destination to which said electronic mail should be transmitted; and
said transmission portion transmits said electronic mail only to the destination identified as a destination to which said electronic mail should be transmitted.

3. An electronic mail system according to claim 2, wherein said specific information of area includes a domain name included in an electronic mail address of the destination to which said electronic mail should be transmitted;
said identification portion compares the destinations included in the header with said domain name and identifies an electronic mail including aid domain name as a destination to which said electronic mail should be transmitted; and
said transmission portion transmits said electronic mail only to the destination identified as a destination to which said electronic mail should be transmitted.

4. An electronic mail system according to claim 1, further comprising:
a second determination portion determining whether or not area designation information is included in said electronic mail; and
an extraction portion extracting a part designated by the area designation information from a body of said electronic mail if it is determined by said second determination portion that the area designating information is included;
and wherein said identification portion identifies at least to which of a first area or a second area the destinations included in the header of said electronic mail belongs to; and
if it is determined that the area designating information is included, said transmission portion transmits said electronic mail to one of the destination belonging to the first area and the destination belonging to the second area, and at the same time, transmits another electronic mail in which the part extracted by said extraction portion is included as a body to the other destination.

5. An electronic mail system according to claim 1, wherein, if it is determined by said determination portion that the destination limiting information is not included, said transmission portion transmits said electronic mail to all the destinations included in the header.

6. An electronic mail system according to claim 1, further comprising:
a keeping portion keeping an electronic mail that is planned to be transmitted for a predetermined time; and
a cancellation portion deleting said electronic mail kept by said keeping portion in accordance with a transmission cancellation instruction obtained before the predetermined time elapses;
and wherein, if said electronic mail kept by said keeping portion is not deleted before the predetermined time elapses, said transmission portion transmits said electronic mail after the predetermined time elapses.

7. An electronic mail system according to claim 6, wherein said transmission portion transmits said electronic mail kept by said keeping portion before the predetermined time elapses in accordance with a forcibly transmission instruction.

8. An electronic mail system according to claim 1, wherein said determination portion, said identification portion and said transmission portion are provided in a mail server for receiving an electronic mail from a mail client or other mail servers, and execute processing for an electronic mail received by said mail server.

9. An electronic mail system according to claim 4, wherein said determination portion, said identification portion, said second determination portion, said extraction portion and said transmission portion are provided in a mail server for receiving an electronic mail from a mail client or other mail servers, and execute processing for an electronic mail received by said mail server.

10. An electronic mail system according to claim 1, wherein said determination portion, said identification portion and said transmission portion are provided in a mail client transmitting an electronic mail to a mail server, and execute processing for an electronic mail to be prepared by said mail client and transmitted to said mail server.

11. An electronic mail system according to claim 4, wherein said determination portion, said identification portion, said second determination portion, said extraction portion and said transmission portion are provided in a mail client for transmitting an electronic mail to a mail server, and execute processing for an electronic mail to be prepared in said mail client and transmitted to said mail server.

12. An electronic mail system according to claim 1, wherein said destination limiting information is added to a header of said electronic mail transmitted to a mail server in a mail client.

13. An electronic mail system according to claim 1, wherein said destination limiting information is added to a header of said electronic mail transmitted to a mail server in a mail client, and said area designation information is added to a body of said electronic mail.

14. An electronic mail system according to claim 1, further comprising: a notification portion notifying the destinations to which said electronic mail was not transmitted by said transmission portion.

15. An electronic mail system according to claim 3, wherein said identification portion prepares a first list in which a destination is registered that is identified as a destination to which said electronic mail should be transmitted among the destinations included in the header based on said destination limiting information; and
said transmission portion transmits an electronic mail with the destination registered in said first list only remaining in the header.

16. An electronic mail system according to claim 15, wherein said identification portion prepares a second list in which destinations are registered that are not identified as a destination to which said electronic mail should be transmitted among the destinations included in the header based on said destination limiting information; and
the fact that said electronic mail was not transmitted to the destinations registered in said second list is notified to a sender of said electronic mail.

17. A method for transmitting electronic mails comprising the steps of:
determining whether or not destination limiting information is included in an electronic mail that is planned to be transmitted;
identifying whether or not said electronic mail should be transmitted to destinations included in a header of said electronic mail based on destination limiting information if it is determined that the destination limiting information is included; and
transmitting said electronic mail only to a destination that is identified as a destination to which said electronic mail should be transmitted.

18. A method for transmitting electronic mails according to claim 17, wherein said destination limiting information includes specific information of an area to which said electronic mail should be transmitted;
said identifying step identifies a destination coinciding with said specific information of an area among the destinations included in said header as a destination to which said electronic mail should be transmitted; and
said transmitting step transmits said electronic mail only to the destination identified as a destination to which said electronic mail should be transmitted.

19. A method for transmitting electronic mails according to claim 18, wherein said specific information of area is a domain name included in an electronic mail address of the destination to which said electronic mail should be transmitted;
said identifying step compares the destinations included in the header with said domain name and identifies an electronic mail including said domain name as a destination to which said electronic mail should be transmitted; and
said transmitting step transmits said electronic mail only to the destination identified as a destination to which said electronic mail should be transmitted.

20. A method for transmitting electronic mails according to claim 17, further comprising:
a second determining step for determining whether or not area designation information is included in said electronic mail; and
an extraction step for extracting a part designated by the area designation information from a body of said electronic mail if it is determined that said area designating information is included;
and wherein said identifying step identifies at least to which of a first area or a second area the destinations included in the header of said electronic mail belong; and
if it is determined that the area designating information is included, said transmitting step transmits said electronic mail to one of the destination belonging to the first area and the destination belonging to the second area, and at the same time, transmits another electronic mail in which the extracted part is included as a body to the other destination.

21. A method for transmitting electronic mails according to claim 17, wherein, if it is determined that the destination limiting information is not included, said electronic mail is transmitted to all the destinations included in the header.

22. A method for transmitting electronic mails according to claim 17, further comprising:
a keeping step for keeping an electronic mail that is planned to be transmitted for a predetermined time; and
a canceling step for deleting said electronic mail kept by said keeping portion in accordance with a transmission cancellation instruction obtained before the predetermined time elapses;
and wherein, if the kept electronic mail is not deleted before the predetermined time elapses, said transmitting step transmits said electronic mail after the predetermined time elapses.

23. A computer readable medium storing a computer program for executing a transmitting process of an electronic mail by a computer, wherein the computer program comprising the steps of:
determining whether or not destination limiting information is included in an electronic mail that is planned to be transmitted;
identifying whether or not said electronic mail should be transmitted to destinations included in a header of said electronic mail based on destination limiting information if it is determined that the destination limiting information is included; and
transmitting said electronic mail only to a destination that is identified as a destination to which said electronic mail should be transmitted.

24. A computer readable medium according to claim 23, wherein said destination limiting information includes specific information of area to which said electronic mail should be transmitted;
said identifying step identifies a destination coinciding with said specific information of area among the destinations included in said header as a destination to which said electronic mail should be transmitted; and
said transmitting step transmits said electronic mail only to the destination identified as a destination to which said electronic mail should be transmitted.

25. A computer readable medium according to claim 24, wherein said specific information of area is a domain name included in an electronic mail address of the destination to which said electronic mail should be transmitted;
said identifying step compares the destinations included in the header with said domain name and identifies an electronic mail address including aid domain name as a destination to which said electronic mail should be transmitted; and
said transmitting step transmits said electronic mail only to the destination identified as a destination to which said electronic mail should be transmitted.

26. A computer readable medium according to claim 23, wherein the computer program further comprises:
a second determining step for determining whether or not area designation information is included in said electronic mail; and
an extraction step extracting a part designated by the area designation information from a body of said electronic mail if it is determined that said area designating information is included;
and wherein said identifying step identifies at least to which of a first area or a second area the destinations included in the header of said electronic mail belongs; and
if it is determined that the area designating information is included, said transmitting step transmits said electronic mail to one of the destination belonging to the first area and the destination belonging to the second area, and at the same time, transmits another electronic mail in which the extracted part is included as a body to the other destination.

27. A computer readable medium according to claim 23, wherein the computer program transmits said electronic mail to all the destinations included in the header if it is determined that the destination limiting information is not included.

28. A computer readable medium storing a computer program for executing a transmitting process of electronic mail by a computer, wherein the computer program comprises:
a keeping step for keeping an electronic mail that is planned to be transmitted for a predetermined time;
a canceling step for deleting said electronic mail kept by said keeping portion in accordance with a transmission cancellation instruction obtained before the predetermined time elapses; and
a transmitting step for transmitting said electronic mail after the predetermined time elapses if the kept electronic mail is not deleted before the predetermined time elapses.

29. An electronic mail system comprising:
a determination portion for determining whether or not destination limiting information is included in a header of an electronic mail that is planned to be transmitted;
an identification portion for identifying, if it is determined by said determination portion that the destination limiting information is included, at least to which of a first area or a second area the destinations included in the header of said electronic mail belong based on the destination limiting information;
a second determination portion for determining whether or not the area designating information is included in said electronic mail;
an extraction portion for extracting a part designated by the area designating information from a text of said electronic mail if it is determined by said second determination portion that the area designating information is included; and
a transmission portion for transmitting said electronic mail to one of the destination belonging to the first area and the destination belonging to the second area, and at the same time, transmits another electronic mail in which the part extracted is included as a body to the other destination.

30. A mail client comprising:
a preparation portion for preparing an electronic mail including a header and a body;
an information adding portion for adding to said electronic mail destination limiting information for transmitting said electronic mail to a destination to which said electronic mail should be transmitted among destinations included in the header of said electronic mail; and
a transmission portion for transmitting the electronic mail added with said destination limiting information to a mail server.

31. A mail client comprising:
a preparation portion for preparing an electronic mail including a header and a body;
a first information adding portion for adding to the header of said electronic mail, destination limiting information for identifying to which of a plurality of areas including a first area and a second area, destinations included in the header of said electronic mail belong;
a second information adding portion for adding to said electronic mail, area designating information for designating a part of a body of said electronic mail to be sent to one of a destination belonging to the first area and a destination belonging to the second area among the plurality of areas; and
a transmission portion for transmitting said electronic mail added with said destination limiting information and said area designating information.
